SEQUENCE LISTING (41 sequences)

SEQ ID NO: 1 - DNA, 1861 bp, Aspergillus Niger
atgccttcctttgcctcttggctcctcacctccgggttggccgccgtggccagcgccatcactgccaatgacagcctcgtggcccggcagattgatacccaacctttcccctatgacttcccccagttgggcgtcaatggttccgatctctttcccatgcgggactgccatggcttcaccttggaggaggccagcatcgatgagatccaggcgcagctgaaggccggtcgcttcaccggctcccagctgctgcagtgctacctcgagcgcatctaccaggtccagccctacaccaagtaagttgcccttcttctcacaaaaatgcggttcgctgattctggtgttccagtgcggtgctgcagttcaaccccgacgccatggccattgccgaggcgttggatgccgaacgcaagcagggtaccgtgcgcggtcccctgcacggcatccccttcctggtcaaggacaacatcgccagtaaggacaagatggagaccaccgcgggcagctgggccctcgtcggctccgtcgtccctcgcgattctcacgtcgtgcatcgtctgcgccaggcgggtgcggtcctgctgggcaaggccacactcagtgagtgggcggacatgcgctccaacgactactccgagggctactcgggccgtggtggccagtgccgcaacccctacaacttcaccgtcaaccccggtggcagtagctccggttccggtgtggctgtcacgagcaaccaggtgccttttgctctgggtaccgagacggatggtagtggtaagtttggcagaccaaaaatatgatgacacaaatatgctaatgtggaggaccagtgatcaacccggccgagcgttcgaacgtggtcggtatcaagcccaccgtgggtctgacctcccgggcgggtgtcatccccgagtccctgcaccaggacacggtcggcacctttggcaagacggtgcgcgatgccgcctatgcgctggatgccatctacggcattgacccccgcgacaacgagacctatgcccagcagggcaagaccccggcgggcgggtacgcccagttcctgaccaaccagacggcgctgaagggggcggtgttcggtctcccctggttgtccttctggcagtacaacgacgccgcacagaacgcccagctgatggaactgctggcgctgatcgaggcggcgggggccaccatcatcaacggcacggagctgccgcactacaaggagattgtggatccgtccggctggaactgggactacggcaccacgcgcggctaccccaaccagtccgagtactcgtacgtcaaggtggatttctacaacaacatccgggactacctggcggagctcaacaacaccaacatgcggtcgctggaggatctggtgcagtacaacctcgacaatgcgggcagtgagggcggggtgccgggcgtcaacccggcgtttgcctcaggccaagacggattcctggcctcgctggccaccaagggcgagatgaacgagacctactggcaggcgctggagtattgccaccgcacgtctcgggaggaggggatcgatgcggccctgcactaccagggtcggaacctcacggcgctgctggtgcctccggactttgccccctcgatcgagattgccgcgcaggcgggttacccggtggtgacgctgcccgcaggtatcaaccaggactcgcatatgccctacggactggcgctgatgggcacggcgttctccgaggccacgctgatcaagtatgccagcgccatcgaggacctgcagctgtcgtccaacacgccgtggaagcgcagcctggccacgtggagcggctacctggaccgaaacattccggtgaactaa

SEQ ID NO: 2 - DNA, 1990 bp, Aspergillus niger
atgactatcccaacctggaaatcaaccgtgcacaagaagcgcgcagctcagctggccgccattccacctgattggcgtctcccggagtccatcactgccgatccgccactcaatgctcttgaggcaatccgctcttgtgatattctcacggagaaagagcaggaatggacggagattaatgatagtactgtgctgctttccatgctggcgaaccgtgagattagctccgttcagcttacgacggcgttctgtaagcgcgcggccgtcgcccagcagcttaccaagtgcttgacggagattttcttcgatagggcgctagcacgggctaaggagctcgatgatattttggaaaagacaggaaaggtgacggggccgttgcatgggctgccggtttcaattaaggatcggtttgatgtcgagggatatgatacaaccgttggttcgtatccatgttctagcatcactgctgctgggagaggagccttggctaactagtggtatgtaggctgggttgggctagtgggcaaacccgcgcaaagctccagcagtattgccttgtcgttggagtcaatgggcgcagtattgtatgtcaagacgaatgtaccacagtctttgatggtatgcaatcacccttttacatttcgcatgatgggagattctgattaagtcagatgtctgattcctacaaccatgtgttcggacaatccatcaatgccttcaacaaacaactcatctccggtgggagttccggcggcgaaggcgccctcattggcacgggtggcagtgtcgttggtatagggacagatatcgggggctcgattcgtatcccggccaatttgcagggtttatactcaatctgtcctactacaggtcgagtgccatggaactgctcgttgtacgtgtccatctctatctactgattctagaccatagctgaccatacccagcatgcaccagcactaccttgttcctccagtcgcaggacccatggcccgcagtctttccagcattgaacatttcatgcaatccctcctcgactccaatccttggaatattgatccgggctgcatcccaattccctggagaaaggaacttgcagcgaagcccactggtaaactacgactcggaattgtctacgacgacggcgtggtaaaaccacagcccccaatcgccagggcaatgcgcgaagttgcaaagaaactcaaagaagctggccatgaaggtgtgtacacaatctacaatctccctcttacctcatcaatcagctttcactgactagacaagtcttcgaatgggacacctccctccacaccacaggccaaaacctctggacaaaagccatcctcgccgacggaggccaacactgtcgctatctatgcgacattgttggagagccactgatagaagggatggttgtagggacagaaaaagatgagctgaccatctcagaacgcgaagaggtcggtcccataccctaatcttctacctctccaatgcttatattaatacaaacatatagctcgaagagaccaaatgggcctaccaaaccagcttcctccagcaatggacatcaagcaacatcgacgccctcctcatgcccgtcacgccctgggtcggctaccggccaaaatcctgggtcgtcagctcccagtggctcggctacacggctctctggaacttgctcaactacgcggctgttactgttccggtggctaaagtggatggagcacttgatcagccggatcaggagtggttggagcatgtgcctaggaatgactcggatcggtttaattgggaacagtgtatgcatactctcctttccatacatacggttatcggggataatagctaaccctatcactatgatctagatgatcccgacctggtcaaagacatgcccatcactgtacaaatcgtcggaggccgctttggcgaagaaaaggccgtttcggtagccaaggtagtagatgaggttttgcaggagccctag

SEQ ID NO: 3 - DNA, 1760 bp, Aspergillus niger
atggcgaacacaacgtgggagcatagagccaagagcaagcaagctcagacggcagcagcgattccaccagaatggactttaccagccgatatacttctcgactcctcggcgaatgtcctcgatgtgcccaggacctgtgggctcctgaccgaaagagaaatccatattaccgaagactatgatgccacagcattacttgaaaagttggctaccggagagttcagctcactcgaggtcacgacagcattctgcaagcgggctgcaattgcgcagcagttgacctgctgcttgacggaaatcttcttcgacaaagcactagccagagcaaagcagctcgacgaaattctggctcaaactggggtaacaaccgggccactgcatggcctgcccataagtatcaaggagtcgttcaatgtccctggagttccgactacactggggttcgtcggatttctcgatcgggccccggcgtccatgagttccgccctggttgagatcctgaacaactgtggggctgttctatatgtcaagaccaatgtcccccagacaatgatgactccggactcccataacaatgtcttcggtcgtgtgctcaacccgcacggacggagcctgaccgctggaggcagcagtggcggagagggagcattggtggcgatgaggggctcagtcctcggcgtggggacagatatcgccggctccattcgcatccccgccctctgctgtggtgtttttggtttcaaacccacggcttgccgtatcccatatgcaggtcaaacgtctgccgggcgtccgggtatgacgggcatcctgccgtccgccgggcccatgtgccattctatccgcgatgcagaactctttctcaaagttgtcctcaactcgaggcctgccgatctggatgactatgcactcgacattccatggtcccctgctccgcaaaaggagaggcttactattgggctcctgcccgaggacccgtcgttcccgcttcatccaccgatgcgacgtaccctgaacgccgcagtgaaggcgctgactacagccggacaccgggtcatcgacctctcaggacaggctccgtccttctccaatgcatgttctctggcattgcgatatttcggcctggacccggatcgaactgcactgcgccacataacgcaggcgggcgaacctttcattccttcgctcaaattcacctatgatctcaatgagccgacacgtgagcccaccttgagagatctattcgaatcgaatgtcgcccgtagtcagctcgcaacccaggcacgaaagctcttcgttgataatcagcttgatctgttcctgggcgcggcttatcaaagcacatcggttccccatgatacctacggtattccggtatataccgtgctttggaacctgattaatgtgggtatcccacactgcctttcttgttttctttttcttttttgtttcccccccttctttctgctccaattgcatggggtgtctgctaatgatgcactagtatccggcgtgcgttatcccatttgggcaggccaacaaggtagaggacgcagcgtataaccgcgacgtctcttatgtgccagactgtaagttgcgcccctcaattggtctcgctcagtctactaactactgtagatcggccagaagaaattgaaggcgcaccgtgtcacatccatctgataggcagaccgatggcggacgaaaaattggttcaggatgcgaagactatatgcaccgtaatgagtgatgtctcttga

SEQ ID NO: 4 - DNA, 1875 bp, Aspergillus niger
atggcagtcgaacagtgggagacgattgtgcaaaagaaacaggccgacgcagccgctaagattccccaggcatggcggctaccggctgaattcacggcgcatgtgtccgaaacagcctctactaatgtgctcgatgtgcctcgcaagtgtggcttgttgtctgctaagcaattggaaattactgagaattatgacgccacggccttgctcgagcagatccattccggaaagttgactgctgttgaagtcgccgaagcattttgccttcgggcggccatcgcacagcaagtggtgggatagtaactcactaaatgaccatgatcgtcaaactaacggtctgatatagacgcgctgtctgactgagacattttttgatcttgctttagagcgagcaaaggagctggacgagtattttcagtctaccggaaaggtccgggggccgctgcacgggctgcccatcagtctcaaggtaggcattgcagccacgaggtataaggacatggatattgatgttatcaggactgcttcaatgtcgctggtgttccaaacacaattggcttcactgccttcatcgcccacggtcccgttaagaacaactcctctgtcgtccagatcctccttgacctgggcgcggttctctatgtcaagaccaacattccccagacaatgatggtatatcccccttcttatattacagctgccgaatgctcatcatgactaggccgccgactcccacaactacgtctttggtcgcaccctcaaccccaaccgaaccaaactcagcgccggcggctcctcaggtggcgaaggcgccctgattgccatgcgcggatcaatcctgggtgtaggcaccgacattgcaggctccatccgcatccccgggatctttgacggaacatatgccctacgcccgtctatccatcgcattccctacggaggccagacaggatccggccgcaagggtctagcgggcatccgaccctgtgccggcccactagccacttccgtgcgagacctcggtctattcatgaaaacagtcgtagacatcgacccctggcaatacgactcctcgaccatcttcagcacctggcgaaccgcccctccgaaagagaccctccgactcggcttcatcctcgaagacccccatttccccgtacaccctcccattctcaacacgctgacccgcgcagtcgatgccctcaaagccgccggccacgaagtcatcaacctaaccaccccatccatcagagacgccctccttctcggcttccgaaccttcgccatggacccggcacgaaccgcattcagccacatcactaagagcggcgagccacgcatccctgctctgagaactaccgatctgccaaacgcagatttgccatttgaatgggccccgcataccctcgagtccctttatgatctgaatgtgcagcgggagacgctgtgcgagcagttccgacagttgatcgtccagaacaagattgacgcgatcattatgccggggtatcagggcacagcggtggcacatgatcaggtcggatgggtgccgtatactgttttggctaatgttttggatgtatgccaactcacccctggatcatgttaagtcgactgacaagtgtagtatccggctacgattattccctacagaaaggcggataaggctgatgacgccaagtatgtcagggatgtgacttaccgaccgccttgtaagttattctcatgtatactctcttaagactgttctgacgctttgcagatgttgcggacgacgtggagggcgcgccgtgctgtgtgcagcttatgggaagaacaatgcacgaggaggagctcctgcgggatactgcgatcgttgccagggtcttggggaaatga

SEQ ID NO: 5 - DNA, 1954 bp, Aspergillus niger
atgcttcccccctttgattactttacgtatcgtcgcatccggtaggttaccccgtgtgccttcacgcagcaacttaagcagtcctacacagcccacatgcaacttagccgacggctcactgaccattcacagggacctcaagaggagggaacgggcggctcgatttgcatcgctatctcccgattatcatgcgcccttctcggctatcgacagggttatcattaacaagcctatccaggacttggtatatgaggtccagaatgattccttggcacctttagatgtcctacgcacatacggcaaggttgcagtcaaggctcacgaaaagaccaattgcgtgactgagcttctattgcctgaggcagaatcatgggctcagtccgaagtaaacctaaaaggtcccctggcgggtgtgcctatctctttgaaagactcggtgcaagtcaaaggattcgatattactctggggtataccaagttcgcgtgtaaaccgtataaggaggatggtccaatggcaaagctgttgaaggatgctggtaggtgacctgtgccgcgaaacatcacagaaagtatccctgcgctaatgatgaactccatcaggtgcggtcccatatgcgaaaacggcgctgcccgtgacgcttctgtcgttcgaatcagcaaacgctctttggggtcactgccttaacccacatgtcccggaatactctcctggcggctcgacgggtggtgaaggtgctctgctggctcttggtggtcgcatcggtatcgggtcggatgtcgctggctcggttcgcgttcccgctgcctggagcggcatctactccctccgctgtagtactggccgctggcctaaggtcggagtcaacaccagcatggctggccaggaaggtgttgccagtgtcttcagtcctatggcccgtactttgaacgatctcacctatttcaccaaagctattgtcggaatgaagccttggaactacgaccataccgtccaccctatctcctggagagaagatgaggaaattgaagcccaaaacaaaaggttgaggatcggcctcatgagcaacgatggtaagttccaagagcggggacatcaaggacactacttgggcctttctgaccacttgcaggtgtcgttcccccaacgccggccattgaacgtgctatttccaccacagtagccgccctcaccgccgctgggcatactgtatctgagatcacaccccccgctgcggctgacacttttactggtctctccctcgcctcgcagctgctcaactctgatgggtgcgtcacgtttaactcgcatctgcacagctttgagccatccgaccctggtgcagatcagctgacgcggatatgcaatctgccccgtcctctacgttatctctactacctttgggttcggtacatccgacgggatgagaagtgggcgacgctgatccgcgggtttgcccccaagtctgcggcggagctttggaagctcactgcccagcgggaagctttccgggcgacctggcacagctggtgggatgccgagacgcagcagtacgatttcatcctctgccccgtcaatgcgacgccggctctgccccacaaagccatgcacgatgcggtatcctcatgcggatacacgttcctctggaacctgctggactacacagccggtgtcgtgcctgtctcgcacgtggacgcgaagaaggatgctctgtctggtccgtacaagaaggtgctgaaacagctgggagccagcaacgcggtggcctacggtgcctggaagcactacgacgcggcgaagatggcgggattgcctactgcagtgcaggtggtgggacgcagatggcaggaagagaaggtgcttggatacatggcggcagttgaggaggccttggagcagtatcaggacccggtaactggagaaggggggaaatacccattgattgagcttgactag

SEQ ID NO: 6 - DNA, 1720 bp, Aspergillus niger
atgtcggtattgttcacttctatttcgccgtatgtactgagtcctcgattcatgttatccccgttgtctcctccacgaatttgaaccttacagatcatcgacagggacaacccggtcaagagggaagatgcggcctcccttctgcgcaatttggatctccatattgaccaagaagatgaggaagattttcataccctcctggcagccgtccatgactgcgccgaaaccgtggcgaacctgccagactatcagccagtccccgatctagatcgataccctcgacataatgttcaccgtccatcctcagaggaacaagtatttgggcaggcctgggctcacaagtttctgatcaagggcaatccggagggagggctattgacggggaagacgatcagcgtgaaggattgcattgccgttgcaggtgtaccacagttgcttggaagtgatatcattccctcttggacaccaattacagatgcgacggttgtgacccgagttctcgatgctggtgctgatattcatggtacttcgacttgtgaaaactactgccattccacggcgtctttcacgagtgctcaaggaaccgtggagaaccctttcgcgaccggatactcagctggcggaagcacctcaggaggggcagccttggttgcagctggtttggttgacattacgctcggtggagaccagggtggaagcattcgggttccctccgcgttttgcggttgtaggtatctcggataaattggctttcagaaacatggctgaccgtgtcaactcaggtgtcggcttgaagcctacatatgggctggtgcctttcagcggtattgctagcggagatgctattgatgaccacacgggcccgcttgctcgtaatgttatcgacgttgcctcttgcttagacgctatcgccggctatgatggcatagacgatcgatgcctggggagtcctaaacacggctctacctcgttcgccaagtcgcttcaagcggacgctacgaggctcgacggcttcaaaataggagtcttgaaggaaggatttgagcacactgctgtggaccccgcagtcaaagagtcggtcatggcggccacccagaaatttgcggagcttggcgcaacagtcgaggaggtatctcttccagaccactaccatgggcctgctatatggaccattcagcagcgtgtatcaggctccttgacgctgcttggacaggcacatggcagaagggggctctacatgacggagatggagcgtgagagactgccgtggacgaaggaaggctttcaaagagccttcccagccacgaagaacgttataatcaatggcctctatcttacctcgcgctttcctgacttgtacgggaaatcagtgaatatcggccgaaggcttcgggacctctacgaggatctgctccaggagtacgatgtggttgtaatgccaaccactcctgttgttgcaccaagacatggtgcacgaggcctaccggtcgagtctctgaagcctagcatgggcttgacaatcaacacagcaatttttgatgttacgggacacccagcgatgagcataccagtggggtacgctccggccaaggatgatccccaagtcaagctcccggtcggtatgcagattgtcggagggttgtggcaggagtttaaggtactcaaagcgggatatgcatgggagaaaaactacgattggaaagaggtggcgagtcattga

SEQ ID NO: 7 - DNA, 1428 bp, Aspergillus niger
atggctcgtatcgatttgtccgagttgactatcgccaaagtgcacacggcattccgccgcggagactacagtgccgtggatctggtccaagcttatttgagacgcatcgaccaggtgaacccgcggctcaatgccatcctggccatcaacccgaatgcggtccaagaagctcaagccctggacgatgccttccgagcttcccgcacattacgcccactccatggggtgccagtgctggtgaaggacaatatcttcaccaccgcgatgccgactacttatggttccaaggtcgccgcgtcgcgcccagtattacccctcgacgatgcccaggtgatcaaacagctgcaaggcgccggggccatcattctggcgaagaccactctgccggattgggcgaccgacttcttcagcgcctcgactgtctcgacgtggacccagaacccctatgacttggctcgagacccgggcggttccagcagcggcaccgccgcggggatcgcagccaacctggctttggtcggcgtgggtacggacacggggggctccatccggctgccctcctcgttctgtagcttggtcggcatgcggcccaccgtcggcctgaccagcctggatggcgtgtccccctttgtgggctgccaagataccgtaggaccgatgtgtcgcaccgtcaccgacgccgcgcgcttactcgacacgctcgtcctgcccaccagcccgcaatccctggctcccagcggaggctcctacgcggcgcatctcctgccagacagcctcccgggtcccgtttgtctgggccatctgccacagctgggtgcggaggaggcggccgtggaggcactcttcactcaggtcctcacccgtctgcgcggacatgcttcggtcaccgtccgggacctcgatattccgagtctctcctccacgctcgcagcagcctctatcatgctcagccgtggccaacatgatctcgacgacttcttgcggaccacggtggggaccagtctgaagacgatctatcgggatcacgcctacccgcccaccaacttcggaataccgggggtagcaacgcatgcttcgaccctgacggaccgctccacggcctccaacgcccgcgatgccctcgaccgcataataacagcccatctgggccaggcgggggtcgaagtactcgtgtttttgaccgcaggacgggcagctccgcgccaggaggatatcaccccggagatgggagtgaccttccccgtgcatgccatgctggccagcacgctgcagtggccagccatctcagtgccaatcgggtttacagcgaccggcctgcccgtgggactggagatcctcggcaggccgctcagcgaccaacgcttgttagaagtggcctttgttatcgagcagattgttcagggacgccgcccccccaccgtagattga

SEQ ID NO: 8 - DNA, 1961 bp, Aspergillus niger
atggacgagaagcctcagttcttccagtatccagaggcccgaccgggtcccgctgtgccgtacaagaacgaggagcaggtgatccccgtcatccgtggctttcccttggccctcggcgccactctgtaagtcctcctgtctgacgtcctgcacttcactcttcttctctctcggccgcagctgcctaatcaccatcctctatagtgttcaaaatatcggctttatccagagccatctctgggggaccactggcttcgatgtcatccgcaacctccctctcgaccaatactccgcccgctatgatccgaccgtgatccccgtagccagacctgatgcttcggctgccgacttgccagttcccacgcaaaagcgacaaagcaatgcaggatactacacttctgccgactatgtagctcgctatacttcgggcgagttgactccccttgccgtcgtcgagaccctgctccctctgatccgccgcgatgccaaaccacccggcaagcactcgatcgcctttcttgaatcgcaagtcgacaagattcgcgccgcagcagaggcttctacacagagatacaaagatggcaagccactgggtccaatggatggcatccccgtcgcaattaaggatgaagtacatatggaaggataccgacggaccctgggcagcaaactcgacttcaccggcgagtttagaggcacctcttggtgtgtgaagcaatgggaggaagccggtgccattgtcattggcaaaaccatcatgcacgagttgggtctaggtgagtagtgcaactcccaacataccccatccgaaccaactaaccaccactttcacccccccagacaccacaaacaacaacccaaatttcggtacccccagaaacccccataaccccgactattactgtggcggctcctctggaggctctggctacgctgtcggcgcaggcctagtccctatcgctctaggcgccgacggcggaggctcaatccgcatcccggcctccttctgcggcgtctggggactgaagccctcccatggccgagtgagcggctctcccaccgtctcactggcatccaccaccggcgtctacggccccctagcctccagcatcgacgacctagccctcgcctaccgaatcatggccacgccggccccagaatcctcagaccccctatcagcagccttcccctcacccctccgcaccctcccctccccaaccaacaacaccccaagaaccatcggcatcgtacgcgactggatcgaccgcgcctcgcctccagtccgcgccgtcttcaacgccaccctcgaccactaccgcacgcttaagaactacaccataatcgacatcacgatcccctacctccccgaggggcaaaaagcgcacgctctaaccatcctatccgaagtgacctcgtccctcaccccttcacagatctcccagctcacgcccgccaacaaaatcatggcttcaatgggcatgtggcaaatcaaaggccaggatttcctcgccgcgcaacgtctccgtaattgtctcatgatgcatctggctcacttgttccagaaacaccctggcttgatgatcgtcacgccgacgacgcctatcccggggtggaagatcgagggcggcgaggcggatcttaagcgcggcgtgtcggatgggaatacgaccgttaggaatatggagtatgtctggttggcgaatttcacgggttgtccggcgattagttgtcctgctgggtatgatgttttggatggtgggtcgagggtgccggtgggggttatggcgatgggagagtgggggagtgaggaggagttgattgcgttcgcgagggatggggagggtgttttggatgggactgctgctgctgatggtatggagcagagctcggggttgacggttcctcggggggaaagggcggcttgggaggatgttattgctaaagctggggagagaagatga

SEQ ID NO: 9 - DNA, 1788 bp, Aspergillus niger
atgtcgctcctgcgggaagccgagaagtgcttggctaatcagggctctcatgcggctctaaatgcgctaattaccaccctacatcagtcaggacaatggttggaacgtgtgagagatgcggatgcgcggcgcacccggggtgagtatgaaggctgcattgaaaccaatcctcgctttattcagagctgaccaactcgcttcgccaaatagggacgcctaaatctgagatagatggccggttggttgccgtcaaggacaatatgtgcacacgcgaccttccaacaacatgcgcttcaaacgctctggacaaattcgtcagtccgtttaacgcgacagtcgttcaacaattggaggatgcaggcgctgtcgtggccgggaaagctaatctcgacgaatttggaatgggctcccactctattcattcaaactttggccctgtcagaagctcgcgccgtggccaggatgcagaatacctctcagccggtggtagttcgggtggaagtgcggttgctgttgcgacagcccaatgttacgcgtatgtaactctccagattagccttgaatcatacgacgagtaacggtttggcttaacattgctggaacatttacagagcgttgggaactgatacaggcggctccgtgcgattacccgcagcatatacgggaacagtcggcttcaagccttcttatgggctggtctctcgctggggagtggttgcgtacgctaattcactggatacagtcggtgtactgggaagggacgtggccagcgttcgccatgtcttcggtatgtcttgattatgtcggaatttctctcgtctctttgcgtctcgactcactaactcgtgttcgaaacataggcgtcgtgaaccagcatgattcacgcgatcccactaacctttctccctccagtcggtcacggatagactcacatcttaaaatgtctgctttggcatctcggacaagttctcctcttaggataggagtccctctcgagtacaacatatcagagttgtctccatctgcgcgacatgcgtggtctcgctctctggcctatttgcaacgacagggccatagcatccaaacggtgtcccttccaacgaccaaactcgccttatcggcatattacgtactcgcgcctgctgaggcatcctcaaacctggccaagtatgatggcgtcaggtacggaagccgccccgaagcaccagacggaaatgcatcatcagaaaggtatctatatgcgaaaacacgaggtgatgggttcggctccgaagtcaaaagacgaattttgctcggggcatttagcctaagcgctgacgctatggataactacttcattcaagcacagcgggttcgccgccttgtccaacatgacttcaacgccgcgtttagggcatgccagccattgatttcctcgcaacttggatcaaagtcgggttctgcagacaccggtgtagatgttctcatttgcccgacagcgccatcatcaccaccacgcatttcaagccttataggacctgatgcgacaacttcgcctttggaggcatatacgaatgatgtatttactgtgcctgctagtttggcaggtcttccggctatatctgtgccggtcactacagaaaatgctgatggcgccgaggatggagatctggctggaatccaagtaattggccaatacggtgatgatgagcttgtgttaaaggttgccgagctgctcgagggcaggcacctatgaaaatttttggttcccataaacgcggataccccagaccccgattatagatgtct

SEQ ID NO: 10 - DNA, 1963 bp, Aspergillus niger
atggtgcgcgctacccaactggctgtggcggccctggggctgcttggtgcagcggccgctcaactggtgtcaacaggcatgtctgtcacgctcgaccagatcgattacttcgtctctccatacccagcgggaaatgtgacggtgtccgcggcctccctgacagatatccccagtgtcaacggcttctatcccgtgactgttgttcaagaggagacggctggggtatcatcactgtcatctcttttctctacgtggacggatgtggatgatgtgtttacgcccgccttcctgggtgcggtcttggtccgtggctacaaacccgacaatgtcactgcaacctttttcaacagttcgcgctccagcgttctcagcccgttagagtccagggttgttccgtcaggcccatacttcctcgaacaggccactggaaatctctatccggtctaccggctctacagcgactatgcaggcgccttcacacagccactactacaaaagccagatggcacattccagccgttgtcggcacaagtggccggtttggtctcatccactatcggtgtgccctctcgcatctactataccccaagcgatgagaaaccgctggccggtgctcgtgttggcgttaaggacatttacagtctcgctggcgtgcggcagagcaatggaaaccgggcatggtacaatctttacggagagaacaatgtcactggcactgccgtatcgcgcctgattgatgcaggcgccatcattgtcggactgcagaagccctcacagtttgcgaacggagaaacggctacagctgactgggtcgaccttcactcgcccttcaacccacgtggagatggctaccaggacccttcttcctcctcgtcaggcgcgggggcttccatcggctcttacgaatggctggacctggctctgggtagtgacaccggcggctctatccgcaatcccgcagaagtccagggagtctacggttcccgtccatcccacggtctcgttgaacttgaccatgtcatgtccatgtcgcctgtgttggacactgcgggagtgctgacaagggatccttatctttgggaccgggccaaccaagccttgtatagcaccaactacacctcgttccatggcaaatcagtccgctaccccagcaagctgtacaccatcgacttcccaacaaccaatgactctgcggcagacgctctgctggctggatttcaaaagcgcctggccgcgttcttgaatacgacaaccaccccgctggatctatctgacgactggtcgtcgcatccgccatccagcgctcccgccaatgtctcgcttgagactttgcttaacctgacctacccaatgctgatcaccaagcagcagatccctctagttagggatcctttctacgccgactatgctggtacgtctggcctaagccttccatatacagcatccgactgacatatacacagctaaacacgacggccgagtccccttcgtcgaccccgttcctctctcccggtggaactggtccatggcgtaccctgactctgcactggatgaagccatccacaacaagacgctcttcatggactggatcgcggagaattatctcactccgatctccgatcctgagcagtgctcctcgtcacttattgtctacgtgggcaccgatggctcccagagagcgcgtaatgtctatcgttcgctccccggcgcaccctcgggctacagcaaattcctcatctccaatatggcgagtgtgccggactttgtcattcctgtgggagagattgaggcctacagcaccatcacgcagcaccaggagaagtttcctgtcgccattgatgttttggctgctaaggggtgtgacggattgctagtcaggctggctcaggatttattcgaggctggcattattaatgcaccgttggcgggtgggacgctgactggtgggccagtcttatcttga

SEQ ID NO: 11 - DNA, 1980 bp, Aspergillus
atggccctcacatcctgggaacaaaccgcagcggccaaacgccaatccgtcctcaacgccatccccgagaaatggcgcatcaagggtcctatccccgcaccgtcggagcagcgcgacgtaacaggcccctacatccagcagttcctatccccacgcgaggttgaaatcaccgaaacagacgccgtagggatcacagagcgaactacaacgggccagtggacagctgtggaggtgaccgaggcgttctgccatcgcgcagcattggcgcatcaactcgtacattccccatccacaaggagtgctagtctgcgctttactaatcgagaaaaaggtaaactgcttgcatgaaatcttcttcgatgccgcgcttgaaaccgcccgcattctagacgaccactacaccaagaccggcaagccactcggtccccttcacggcctccctgtcagtctgaaggatcaattccacgtcaagggcgtagaaacaaccatgggttacgtcggctggataaacaccttccaaggcaagaccaatgacccgcgctatcttacacacgaaagcgaactcgttaaagaactccgcgccgcgggagccgtcctctactgcaagactagcgtccccatgacgttgatgtcaggtgaaaccatgaacaatatcataacttacacacataacccgaagaacaggcttctcagttctggaggtagttccgggggcgaaggagcactgatcgcgttgcggggatcaccagccgggtttggtacggatatcgggggtagtatccgtgttcctgcgtcgttcaatggactgtatgggatacggccgtctgtggggagaatgccgtacgagggggcggccaattcgggcgatggacagaatactgtgttgtcggttgtggggccgttgtctccttcggcgagagggttgatattgctgttcaagacggtgttgggggcaatgccgtggttgggagatcctggtgtgttggagattccctggagggaggaaatcgtagaggagacgagaaaattagtgcagggaaagccagaggggctagcttttggaatattctacgatgatggtcaggtaaagccgcagccaccggtcgagagagcgatgcggattgctgcagagacgatcaagcgtctaggacataaggtgagtgccctccttcttcttgcgacactgctaacattcatcccagctcatcaattgggaacccccctctcacctaacagccgcctccctcgcagtaagtcccccatccaacccactacaccacaaccccctaacaataaaccaacccccagaaccgcgcctacaacatggacggcggcgccgacgtactccaaaacttcgccctgtccaacgaagccatccacacctccgtagtaatcgacgcatcaggatccccccaaaagaccgcactagagatcgccgcgctaaacgtcgagaagcgcgaataccagaaacaataccttgactactggaacagcacggcgcaattgacagggactggacgacccgtcgacgcggtcatttgtccagtggcgccgcatgcggcgtgcattccggggaagtatgcgacgatcgggtatacggcgtttattaatgtgttggattatacgagtgcggttgtgccggttacgagtgctgataggagggtggatgttgtagggaaggaaggaagggagtattttggggagttggataggaagaccgagggggagtgtaagttcttccctttcttttcttctttcttttcattgagctatccaatttggttggaggtcttgtgtgtttgtttgttcggagagtggtgatggggttatgtgctgactggatgtttctatctagacgatgcggatgtgtttgatggggcgccggctgggattcagctctttggaagacggcttcaggaggagaagattctggtactggctgagtatcttggtgaggaattcaagaaggctagtgcttga

SEQ ID NO: 12 - DNA, 1752 bp, Aspergillus niger
atgccttcctttgcctcttggctcctcacctccgggttggccgccgtggccagcgccatcactgccaatgacagcctcgtggcccggcagattgatacccaacctttcccctatgacttcccccagttgggcgtcaatggttccgatctctttcccatgcgggactgccatggcttcaccttggaggaggccagcatcgatgagatccaggcgcagctgaaggccggtcgcttcaccggctcccagctgctgcagtgctacctcgagcgcatctaccaggtccagccctacaccaatgcggtgctgcagttcaaccccgacgccatggccattgccgaggcgttggatgccgaacgcaagcagggtaccgtgcgcggtcccctgcacggcatccccttcctggtcaaggacaacatcgccagtaaggacaagatggagaccaccgcgggcagctgggccctcgtcggctccgtcgtccctcgcgattctcacgtcgtgcatcgtctgcgccaggcgggtgcggtcctgctgggcaaggccacactcagtgagtgggcggacatgcgctccaacgactactccgagggctactcgggccgtggtggccagtgccgcaacccctacaacttcaccgtcaaccccggtggcagtagctccggttccggtgtggctgtcacgagcaaccaggtgccttttgctctgggtaccgagacggatggtagtgtgatcaacccggccgagcgttcgaacgtggtcggtatcaagcccaccgtgggtctgacctcccgggcgggtgtcatccccgagtccctgcaccaggacacggtcggcacctttggcaagacggtgcgcgatgccgcctatgcgctggatgccatctacggcattgacccccgcgacaacgagacctatgcccagcagggcaagaccccggcgggcgggtacgcccagttcctgaccaaccagacggcgctgaagggggcggtgttcggtctcccctggttgtccttctggcagtacaacgacgccgcacagaacgcccagctgatggaactgctggcgctgatcgaggcggcgggggccaccatcatcaacggcacggagctgccgcactacaaggagattgtggatccgtccggctggaactgggactacggcaccacgcgcggctaccccaaccagtccgagtactcgtacgtcaaggtggatttctacaacaacatccgggactacctggcggagctcaacaacaccaacatgcggtcgctggaggatctggtgcagtacaacctcgacaatgcgggcagtgagggcggggtgccgggcgtcaacccggcgtttgcctcaggccaagacggattcctggcctcgctggccaccaagggcgagatgaacgagacctactggcaggcgctggagtattgccaccgcacgtctcgggaggaggggatcgatgcggccctgcactaccagggtcggaacctcacggcgctgctggtgcctccggactttgccccctcgatcgagattgccgcgcaggcgggttacccggtggtgacgctgcccgcaggtatcaaccaggactcgcatatgccctacggactggcgctgatgggcacggcgttctccgaggccacgctgatcaagtatgccagcgccatcgaggacctgcagctgtcgtccaacacgccgtggaagcgcagcctggccacgtggagcggctacctggaccgaaacattccggtgaactaa

SEQ ID NO: 13 - DNA, 1494 bp, Aspergillus niger
atgactatcccaacctggaaatcaaccgtgcacaagaagcgcgcagctcagctggccgccattccacctgattggcgtctcccggagtccatcactgccgatccgccactcaatgctcttgaggcaatccgctcttgtgatattctcacggagaaagagcaggaatggacggagattaatgatagtactgtgctgctttccatgctggcgaaccgtgagattagctccgttcagcttacgacggcgttctgtaagcgcgcggccgtcgcccagcagcttaccaagtgcttgacggagattttcttcgatagggcgctagcacgggctaaggagctcgatgatattttggaaaagacaggaaaggtgacggggccgttgcatgggctgccggtttcaattaaggatcggtttgatgtcgagggatatgatacaaccgttggctgggttgggctagtgggcaaacccgcgcaaagctccagcagtattgccttgtcgttggagtcaatgggcgcagtattgtatgtcaagacgaatgtaccacagtctttgatgatgtctgattcctacaaccatgtgttcggacaatccatcaatgccttcaacaaacaactcatctccggtgggagttccggcggcgaaggcgccctcattggcacgggtggcagtgtcgttggtatagggacagatatcgggggctcgattcgtatcccggccaatttgcagggtttatactcaatctgtcctactacaggtcgagtgccatggaactgctcgttcatgcaccagcactaccttgttcctccagtcgcaggacccatggcccgcagtctttccagcattgaacatttcatgcaatccctcctcgactccaatccttggaatattgatccgggctgcatcccaattccctggagaaaggaacttgcagcgaagcccactggtaaactacgactcggaattgtctacgacgacggcgtggtaaaaccacagcccccaatcgccagggcaatgcgcgaagttgcaaagaaactcaaagaagctggccatgaagggacagaaaaagatgagctgaccatctcagaacgcgaagagctcgaagagaccaaatgggcctaccaaaccagcttcctccagcaatggacatcaagcaacatcgacgccctcctcatgcccgtcacgccctgggtcggctaccggccaaaatcctgggtcgtcagctcccagtggctcggctacacggctctctggaacttgctcaactacgcggctgttactgttccggtggctaaagtggatggagcacttgatcagccggatcaggagtggttggagcatgtgcctaggaatgactcggatcggtttaattgggaacagtatgatcccgacctggtcaaagacatgcccatcactgtacaaatcgtcggaggccgctttggcgaagaaaaggccgtttcggtagccaaggtagtagatgaggttttgcaggagccctag

SEQ ID NO: 14 - DNA, 1611 bp, Aspergillus niger
atggcgaacacaacgtgggagcatagagccaagagcaagcaagctcagacggcagcagcgattccaccagaatggactttaccagccgatatacttctcgactcctcggcgaatgtcctcgatgtgcccaggacctgtgggctcctgaccgaaagagaaatccatattaccgaagactatgatgccacagcattacttgaaaagttggctaccggagagttcagctcactcgaggtcacgacagcattctgcaagcgggctgcaattgcgcagcagttgacctgctgcttgacggaaatcttcttcgacaaagcactagccagagcaaagcagctcgacgaaattctggctcaaactggggtaacaaccgggccactgcatggcctgcccataagtatcaaggagtcgttcaatgtccctggagttccgactacactggggttcgtcggatttctcgatcgggccccggcgtccatgagttccgccctggttgagatcctgaacaactgtggggctgttctatatgtcaagaccaatgtcccccagacaatgatgactccggactcccataacaatgtcttcggtcgtgtgctcaacccgcacggacggagcctgaccgctggaggcagcagtggcggagagggagcattggtggcgatgaggggctcagtcctcggcgtggggacagatatcgccggctccattcgcatccccgccctctgctgtggtgtttttggtttcaaacccacggcttgccgtatcccatatgcaggtcaaacgtctgccgggcgtccgggtatgacgggcatcctgccgtccgccgggcccatgtgccattctatccgcgatgcagaactctttctcaaagttgtcctcaactcgaggcctgccgatctggatgactatgcactcgacattccatggtcccctgctccgcaaaaggagaggcttactattgggctcctgcccgaggacccgtcgttcccgcttcatccaccgatgcgacgtaccctgaacgccgcagtgaaggcgctgactacagccggacaccgggtcatcgacctctcaggacaggctccgtccttctccaatgcatgttctctggcattgcgatatttcggcctggacccggatcgaactgcactgcgccacataacgcaggcgggcgaacctttcattccttcgctcaaattcacctatgatctcaatgagccgacacgtgagcccaccttgagagatctattcgaatcgaatgtcgcccgtagtcagctcgcaacccaggcacgaaagctcttcgttgataatcagcttgatctgttcctgggcgcggcttatcaaagcacatcggttccccatgatacctacggtattccggtatataccgtgctttggaacctgattaattatccggcgtgcgttatcccatttgggcaggccaacaaggtagaggacgcagcgtataaccgcgacgtctcttatgtgccagactatcggccagaagaaattgaaggcgcaccgtgtcacatccatctgataggcagaccgatggcggacgaaaaattggttcaggatgcgaagactatatgcaccgtaatgagtgatgtctcttga

SEQ ID NO: 15 - DNA, 1623 bp, Aspergillus niger
atggcagtcgaacagtgggagacgattgtgcaaaagaaacaggccgacgcagccgctaagattccccaggcatggcggctaccggctgaattcacggcgcatgtgtccgaaacagcctctactaatgtgctcgatgtgcctcgcaagtgtggcttgttgtctgctaagcaattggaaattactgagaattatgacgccacggccttgctcgagcagatccattccggaaagttgactgctgttgaagtcgccgaagcattttgccttcgggcggccatcgcacagcaagtgacgcgctgtctgactgagacattttttgatcttgctttagagcgagcaaaggagctggacgagtattttcagtctaccggaaaggtccgggggccgctgcacgggctgcccatcagtctcaaggactgcttcaatgtcgctggtgttccaaacacaattggcttcactgccttcatcgcccacggtcccgttaagaacaactcctctgtcgtccagatcctccttgacctgggcgcggttctctatgtcaagaccaacattccccagacaatgatggccgccgactcccacaactacgtctttggtcgcaccctcaaccccaaccgaaccaaactcagcgccggcggctcctcaggtggcgaaggcgccctgattgccatgcgcggatcaatcctgggtgtaggcaccgacattgcaggctccatccgcatccccgggatctttgacggaacatatgccctacgcccgtctatccatcgcattccctacggaggccagacaggatccggccgcaagggtctagcgggcatccgaccctgtgccggcccactagccacttccgtgcgagacctcggtctattcatgaaaacagtcgtagacatcgacccctggcaatacgactcctcgaccatcttcagcacctggcgaaccgcccctccgaaagagaccctccgactcggcttcatcctcgaagacccccatttccccgtacaccctcccattctcaacacgctgacccgcgcagtcgatgccctcaaagccgccggccacgaagtcatcaacctaaccaccccatccatcagagacgccctccttctcggcttccgaaccttcgccatggacccggcacgaaccgcattcagccacatcactaagagcggcgagccacgcatccctgctctgagaactaccgatctgccaaacgcagatttgccatttgaatgggccccgcataccctcgagtccctttatgatctgaatgtgcagcgggagacgctgtgcgagcagttccgacagttgatcgtccagaacaagattgacgcgatcattatgccggggtatcagggcacagcggtggcacatgatcaggtcggatgggtgccgtatactgttttggctaatgttttggattatccggctacgattattccctacagaaaggcggataaggctgatgacgccaagtatgtcagggatgtgacttaccgaccgccttatgttgcggacgacgtggagggcgcgccgtgctgtgtgcagcttatgggaagaacaatgcacgaggaggagctcctgcgggatactgcgatcgttgccagggtcttggggaaatga

SEQ ID NO: 16 - DNA, 1740 bp, Aspergillus niger
atgcttcccccctttgattactttacgtatcgtcgcatccgggacctcaagaggagggaacgggcggctcgatttgcatcgctatctcccgattatcatgcgcccttctcggctatcgacagggttatcattaacaagcctatccaggacttggtatatgaggtccagaatgattccttggcacctttagatgtcctacgcacatacggcaaggttgcagtcaaggctcacgaaaagaccaattgcgtgactgagcttctattgcctgaggcagaatcatgggctcagtccgaagtaaacctaaaaggtcccctggcgggtgtgcctatctctttgaaagactcggtgcaagtcaaaggattcgatattactctggggtataccaagttcgcgtgtaaaccgtataaggaggatggtccaatggcaaagctgttgaaggatgctggtgcggtcccatatgcgaaaacggcgctgcccgtgacgcttctgtcgttcgaatcagcaaacgctctttggggtcactgccttaacccacatgtcccggaatactctcctggcggctcgacgggtggtgaaggtgctctgctggctcttggtggtcgcatcggtatcgggtcggatgtcgctggctcggttcgcgttcccgctgcctggagcggcatctactccctccgctgtagtactggccgctggcctaaggtcggagtcaacaccagcatggctggccaggaaggtgttgccagtgtcttcagtcctatggcccgtactttgaacgatctcacctatttcaccaaagctattgtcggaatgaagccttggaactacgaccataccgtccaccctatctcctggagagaagatgaggaaattgaagcccaaaacaaaaggttgaggatcggcctcatgagcaacgatggtgtcgttcccccaacgccggccattgaacgtgctatttccaccacagtagccgccctcaccgccgctgggcatactgtatctgagatcacaccccccgctgcggctgacacttttactggtctctccctcgcctcgcagctgctcaactctgatgggtgcgtcacgtttaactcgcatctgcacagctttgagccatccgaccctggtgcagatcagctgacgcggatatgcaatctgccccgtcctctacgttatctctactacctttgggttcggtacatccgacgggatgagaagtgggcgacgctgatccgcgggtttgcccccaagtctgcggcggagctttggaagctcactgcccagcgggaagctttccgggcgacctggcacagctggtgggatgccgagacgcagcagtacgatttcatcctctgccccgtcaatgcgacgccggctctgccccacaaagccatgcacgatgcggtatcctcatgcggatacacgttcctctggaacctgctggactacacagccggtgtcgtgcctgtctcgcacgtggacgcgaagaaggatgctctgtctggtccgtacaagaaggtgctgaaacagctgggagccagcaacgcggtggcctacggtgcctggaagcactacgacgcggcgaagatggcgggattgcctactgcagtgcaggtggtgggacgcagatggcaggaagagaaggtgcttggatacatggcggcagttgaggaggccttggagcagtatcaggacccggtaactggagaaggggggaaatacccattgattgagcttgactag

SEQ ID NO: 17 - DNA, 1590 bp, Aspergillus niger
atgtcggtattgttcacttctatttcgccggacaacccggtcaagagggaagatgcggcctcccttctgcgcaatttggatctccatattgaccaagaagatgaggaagattttcataccctcctggcagccgtccatgactgcgccgaaaccgtggcgaacctgccagactatcagccagtccccgatctagatcgataccctcgacataatgttcaccgtccatcctcagaggaacaagtatttgggcaggcctgggctcacaagtttctgatcaagggcaatccggagggagggctattgacggggaagacgatcagcgtgaaggattgcattgccgttgcaggtgtaccacagttgcttggaagtgatatcattccctcttggacaccaattacagatgcgacggttgtgacccgagttctcgatgctggtgctgatattcatggtacttcgacttgtgaaaactactgccattccacggcgtctttcacgagtgctcaaggaaccgtggagaaccctttcgcgaccggatactcagctggcggaagcacctcaggaggggcagccttggttgcagctggtttggttgacattacgctcggtggagaccagggtggaagcattcgggttccctccgcgttttgcggttgtgtcggcttgaagcctacatatgggctggtgcctttcagcggtattgctagcggagatgctattgatgaccacacgggcccgcttgctcgtaatgttatcgacgttgcctcttgcttagacgctatcgccggctatgatggcatagacgatcgatgcctggggagtcctaaacacggctctacctcgttcgccaagtcgcttcaagcggacgctacgaggctcgacggcttcaaaataggagtcttgaaggaaggatttgagcacactgctgtggaccccgcagtcaaagagtcggtcatggcggccacccagaaatttgcggagcttggcgcaacagtcgaggaggtatctcttccagaccactaccatgggcctgctatatggaccattcagcagcgtgtatcaggctccttgacgctgcttggacaggcacatggcagaagggggctctacatgacggagatggagcgtgagagactgccgtggacgaaggaaggctttcaaagagccttcccagccacgaagaacgttataatcaatggcctctatcttacctcgcgctttcctgacttgtacgggaaatcagtgaatatcggccgaaggcttcgggacctctacgaggatctgctccaggagtacgatgtggttgtaatgccaaccactcctgttgttgcaccaagacatggtgcacgaggcctaccggtcgagtctctgaagcctagcatgggcttgacaatcaacacagcaatttttgatgttacgggacacccagcgatgagcataccagtggggtacgctccggccaaggatgatccccaagtcaagctcccggtcggtatgcagattgtcggagggttgtggcaggagtttaaggtactcaaagcgggatatgcatgggagaaaaactacgattggaaagaggtggcgagtcattga

SEQ ID NO: 18 - DNA, 1428 bp, Aspergillus niger; identical to SEQ ID NO: 7

SEQ ID NO: 19 - DNA, 1818 bp, Aspergillus niger
atggacgagaagcctcagttcttccagtatccagaggcccgaccgggtcccgctgtgccgtacaagaacgaggagcaggtgatccccgtcatccgtggctttcccttggccctcggcgccactcttgttcaaaatatcggctttatccagagccatctctgggggaccactggcttcgatgtcatccgcaacctccctctcgaccaatactccgcccgctatgatccgaccgtgatccccgtagccagacctgatgcttcggctgccgacttgccagttcccacgcaaaagcgacaaagcaatgcaggatactacacttctgccgactatgtagctcgctatacttcgggcgagttgactccccttgccgtcgtcgagaccctgctccctctgatccgccgcgatgccaaaccacccggcaagcactcgatcgcctttcttgaatcgcaagtcgacaagattcgcgccgcagcagaggcttctacacagagatacaaagatggcaagccactgggtccaatggatggcatccccgtcgcaattaaggatgaagtacatatggaaggataccgacggaccctgggcagcaaactcgacttcaccggcgagtttagaggcacctcttggtgtgtgaagcaatgggaggaagccggtgccattgtcattggcaaaaccatcatgcacgagttgggtctagacaccacaaacaacaacccaaatttcggtacccccagaaacccccataaccccgactattactgtggcggctcctctggaggctctggctacgctgtcggcgcaggcctagtccctatcgctctaggcgccgacggcggaggctcaatccgcatcccggcctccttctgcggcgtctggggactgaagccctcccatggccgagtgagcggctctcccaccgtctcactggcatccaccaccggcgtctacggccccctagcctccagcatcgacgacctagccctcgcctaccgaatcatggccacgccggccccagaatcctcagaccccctatcagcagccttcccctcacccctccgcaccctcccctccccaaccaacaacaccccaagaaccatcggcatcgtacgcgactggatcgaccgcgcctcgcctccagtccgcgccgtcttcaacgccaccctcgaccactaccgcacgcttaagaactacaccataatcgacatcacgatcccctacctccccgaggggcaaaaagcgcacgctctaaccatcctatccgaagtgacctcgtccctcaccccttcacagatctcccagctcacgcccgccaacaaaatcatggcttcaatgggcatgtggcaaatcaaaggccaggatttcctcgccgcgcaacgtctccgtaattgtctcatgatgcatctggctcacttgttccagaaacaccctggcttgatgatcgtcacgccgacgacgcctatcccggggtggaagatcgagggcggcgaggcggatcttaagcgcggcgtgtcggatgggaatacgaccgttaggaatatggagtatgtctggttggcgaatttcacgggttgtccggcgattagttgtcctgctgggtatgatgttttggatggtgggtcgagggtgccggtgggggttatggcgatgggagagtgggggagtgaggaggagttgattgcgttcgcgagggatggggagggtgttttggatgggactgctgctgctgatggtatggagcagagctcggggttgacggttcctcggggggaaagggcggcttgggaggatgttattgctaaagctggggagagaagatga

SEQ ID NO: 20 - DNA, 1515 bp, Aspergillus niger
atgtcgctcctgcgggaagccgagaagtgcttggctaatcagggctctcatgcggctctaaatgcgctaattaccaccctacatcagtcaggacaatggttggaacgtgtgagagatgcggatgcgcggcgcacccgggggacgcctaaatctgagatagatggccggttggttgccgtcaaggacaatatgtgcacacgcgaccttccaacaacatgcgcttcaaacgctctggacaaattcgtcagtccgtttaacgcgacagtcgttcaacaattggaggatgcaggcgctgtcgtggccgggaaagctaatctcgacgaatttggaatgggctcccactctattcattcaaactttggccctgtcagaagctcgcgccgtggccaggatgcagaatacctctcagccggtggtagttcgggtggaagtgcggttgctgttgcgacagcccaatgttacgcagcgttgggaactgatacaggcggctccgtgcgattacccgcagcatatacgggaacagtcggcttcaagccttcttatgggctggtctctcgctggggagtggttgcgtacgctaattcactggatacagtcggtgtactgggaagggacgtggccagcgttcgccatgtcttcggcgtcgtgaaccagcatgattcacgcgatcccactaacctttctccctccagtcggtcacggatagactcacatcttaaaatgtctgctttggcatctcggacaagttctcctcttaggataggagtccctctcgagtacaacatatcagagttgtctccatctgcgcgacatgcgtggtctcgctctctggcctatttgcaacgacagggccatagcatccaaacggtgtcccttccaacgaccaaactcgccttatcggcatattacgtactcgcgcctgctgaggcatcctcaaacctggccaagtatgatggcgtcaggtacggaagccgccccgaagcaccagacggaaatgcatcatcagaaaggtatctatatgcgaaaacacgaggtgatgggttcggctccgaagtcaaaagacgaattttgctcggggcatttagcctaagcgctgacgctatggataactacttcattcaagcacagcgggttcgccgccttgtccaacatgacttcaacgccgcgtttagggcatgccagccattgatttcctcgcaacttggatcaaagtcgggttctgcagacaccggtgtagatgttctcatttgcccgacagcgccatcatcaccaccacgcatttcaagccttataggacctgatgcgacaacttcgcctttggaggcatatacgaatgatgtatttactgtgcctgctagtttggcaggtcttccggctatatctgtgccggtcactacagaaaatgctgatggcgccgaggatggagatctggctggaatccaagtaattggccaatacggtgatgatgagcttgtgttaaaggttgccgagctgctcgagggcaggcacctatga

SEQ ID NO: 21 - DNA, 1911 bp, Aspergillus niger
atggtgcgcgctacccaactggctgtggcggccctggggctgcttggtgcagcggccgctcaactggtgtcaacaggcatgtctgtcacgctcgaccagatcgattacttcgtctctccatacccagcgggaaatgtgacggtgtccgcggcctccctgacagatatccccagtgtcaacggcttctatcccgtgactgttgttcaagaggagacggctggggtatcatcactgtcatctcttttctctacgtggacggatgtggatgatgtgtttacgcccgccttcctgggtgcggtcttggtccgtggctacaaacccgacaatgtcactgcaacctttttcaacagttcgcgctccagcgttctcagcccgttagagtccagggttgttccgtcaggcccatacttcctcgaacaggccactggaaatctctatccggtctaccggctctacagcgactatgcaggcgccttcacacagccactactacaaaagccagatggcacattccagccgttgtcggcacaagtggccggtttggtctcatccactatcggtgtgccctctcgcatctactataccccaagcgatgagaaaccgctggccggtgctcgtgttggcgttaaggacatttacagtctcgctggcgtgcggcagagcaatggaaaccgggcatggtacaatctttacggagagaacaatgtcactggcactgccgtatcgcgcctgattgatgcaggcgccatcattgtcggactgcagaagccctcacagtttgcgaacggagaaacggctacagctgactgggtcgaccttcactcgcccttcaacccacgtggagatggctaccaggacccttcttcctcctcgtcaggcgcgggggcttccatcggctcttacgaatggctggacctggctctgggtagtgacaccggcggctctatccgcaatcccgcagaagtccagggagtctacggttcccgtccatcccacggtctcgttgaacttgaccatgtcatgtccatgtcgcctgtgttggacactgcgggagtgctgacaagggatccttatctttgggaccgggccaaccaagccttgtatagcaccaactacacctcgttccatggcaaatcagtccgctaccccagcaagctgtacaccatcgacttcccaacaaccaatgactctgcggcagacgctctgctggctggatttcaaaagcgcctggccgcgttcttgaatacgacaaccaccccgctggatctatctgacgactggtcgtcgcatccgccatccagcgctcccgccaatgtctcgcttgagactttgcttaacctgacctacccaatgctgatcaccaagcagcagatccctctagttagggatcctttctacgccgactatgctgctaaacacgacggccgagtccccttcgtcgaccccgttcctctctcccggtggaactggtccatggcgtaccctgactctgcactggatgaagccatccacaacaagacgctcttcatggactggatcgcggagaattatctcactccgatctccgatcctgagcagtgctcctcgtcacttattgtctacgtgggcaccgatggctcccagagagcgcgtaatgtctatcgttcgctccccggcgcaccctcgggctacagcaaattcctcatctccaatatggcgagtgtgccggactttgtcattcctgtgggagagattgaggcctacagcaccatcacgcagcaccaggagaagtttcctgtcgccattgatgttttggctgctaaggggtgtgacggattgctagtcaggctggctcaggatttattcgaggctggcattattaatgcaccgttggcgggtgggacgctgactggtgggccagtcttatcttga

SEQ ID NO: 22 - DNA, 1695 bp, Aspergillus niger
atggccctcacatcctgggaacaaaccgcagcggccaaacgccaatccgtcctcaacgccatccccgagaaatggcgcatcaagggtcctatccccgcaccgtcggagcagcgcgacgtaacaggcccctacatccagcagttcctatccccacgcgaggttgaaatcaccgaaacagacgccgtagggatcacagagcgaactacaacgggccagtggacagctgtggaggtgaccgaggcgttctgccatcgcgcagcattggcgcatcaactcgtaaactgcttgcatgaaatcttcttcgatgccgcgcttgaaaccgcccgcattctagacgaccactacaccaagaccggcaagccactcggtccccttcacggcctccctgtcagtctgaaggatcaattccacgtcaagggcgtagaaacaaccatgggttacgtcggctggataaacaccttccaaggcaagaccaatgacccgcgctatcttacacacgaaagcgaactcgttaaagaactccgcgccgcgggagccgtcctctactgcaagactagcgtccccatgacgttgatgtcaggtgaaaccatgaacaatatcataacttacacacataacccgaagaacaggcttctcagttctggaggtagttccgggggcgaaggagcactgatcgcgttgcggggatcaccagccgggtttggtacggatatcgggggtagtatccgtgttcctgcgtcgttcaatggactgtatgggatacggccgtctgtggggagaatgccgtacgagggggcggccaattcgggcgatggacagaatactgtgttgtcggttgtggggccgttgtctccttcggcgagagggttgatattgctgttcaagacggtgttgggggcaatgccgtggttgggagatcctggtgtgttggagattccctggagggaggaaatcgtagaggagacgagaaaattagtgcagggaaagccagaggggctagcttttggaatattctacgatgatggtcaggtaaagccgcagccaccggtcgagagagcgatgcggattgctgcagagacgatcaagcgtctaggacataagctcatcaattgggaacccccctctcacctaacagccgcctccctcgcaaaccgcgcctacaacatggacggcggcgccgacgtactccaaaacttcgccctgtccaacgaagccatccacacctccgtagtaatcgacgcatcaggatccccccaaaagaccgcactagagatcgccgcgctaaacgtcgagaagcgcgaataccagaaacaataccttgactactggaacagcacggcgcaattgacagggactggacgacccgtcgacgcggtcatttgtccagtggcgccgcatgcggcgtgcattccggggaagtatgcgacgatcgggtatacggcgtttattaatgtgttggattatacgagtgcggttgtgccggttacgagtgctgataggagggtggatgttgtagggaaggaaggaagggagtattttggggagttggataggaagaccgagggggagtacgatgcggatgtgtttgatggggcgccggctgggattcagctctttggaagacggcttcaggaggagaagattctggtactggctgagtatcttggtgaggaattcaagaaggctagtgcttga

SEQ ID NO: 23 - protein, 583 aa, Aspergillus niger
MPSFASWLLTSGLAAVASAITANDSLVARQIDTQPFPYDFPQLGVNGSDLFPMRDCHGFTLEEASIDEIQAQLKAGRFTGSQLLQCYLERIYQVQPYTNAVLQFNPDAMAIAEALDAERKQGTVRGPLHGIPFLVKDNIASKDKMETTAGSWALVGSVVPRDSHVVHRLRQAGAVLLGKATLSEWADMRSNDYSEGYSGRGGQCRNPYNFTVNPGGSSSGSGVAVTSNQVPFALGTETDGSVINPAERSNVVGIKPTVGLTSRAGVIPESLHQDTVGTFGKTVRDAAYALDAIYGIDPRDNETYAQQGKTPAGGYAQFLTNQTALKGAVFGLPWLSFWQYNDAAQNAQLMELLALIEAAGATIINGTELPHYKEIVDPSGWNWDYGTTRGYPNQSEYSYVKVDFYNNIRDYLAELNNTNMRSLEDLVQYNLDNAGSEGGVPGVNPAFASGQDGFLASLATKGEMNETYWQALEYCHRTSREEGIDAALHYQGRNLTALLVPPDFAPSIEIAAQAGYPVVTLPAGINQDSHMPYGLALMGTAFSEATLIKYASAIEDLQLSSNTPWKRSLATWSGYLDRNIPVN

SEQ ID NO: 24 - protein, 497 aa, Aspergillus niger
MTIPTWKSTVHKKRAAQLAAIPPDWRLPESITADPPLNALEAIRSCDILTEKEQEWTEINDSTVLLSMLANREISSVQLTTAFCKRAAVAQQLTKCLTEIFFDRALARAKELDDILEKTGKVTGPLHGLPVSIKDRFDVEGYDTTVGWVGLVGKPAQSSSSIALSLESMGAVLYVKTNVPQSLMMSDSYNHVFGQSINAFNKQLISGGSSGGEGALIGTGGSVVGIGTDIGGSIRIPANLQGLYSICPTTGRVPWNCSFMHQHYLVPPVAGPMARSLSSIEHFMQSLLDSNPWNIDPGCIPIPWRKELAAKPTGKLRLGIVYDDGVVKPQPPIARAMREVAKKLKEAGHEGTEKDELTISEREELEETKWAYQTSFLQQWTSSNIDALLMPVTPWVGYRPKSWVVSSQWLGYTALWNLLNYAAVTVPVAKVDGALDQPDQEWLEHVPRNDSDRFNWEQYDPDLVKDMPITVQIVGGRFGEEKAVSVAKVVDEVLQEP

SEQ ID NO: 25 - protein, 536 aa, Aspergillus niger
MANTTWEHRAKSKQAQTAAAIPPEWTLPADILLDSSANVLDVPRTCGLLTEREIHITEDYDATALLEKLATGEFSSLEVTTAFCKRAAIAQQLTCCLTEIFFDKALARAKQLDEILAQTGVTTGPLHGLPISIKESFNVPGVPTTLGFVGFLDRAPASMSSALVEILNNCGAVLYVKTNVPQTMMTPDSHNNVFGRVLNPHGRSLTAGGSSGGEGALVAMRGSVLGVGTDIAGSIRIPALCCGVFGFKPTACRIPYAGQTSAGRPGMTGILPSAGPMCHSIRDAELFLKVVLNSRPADLDDYALDIPWSPAPQKERLTIGLLPEDPSFPLHPPMRRTLNAAVKALTTAGHRVIDLSGQAPSFSNACSLALRYFGLDPDRTALRHITQAGEPFIPSLKFTYDLNEPTREPTLRDLFESNVARSQLATQARKLFVDNQLDLFLGAAYQSTSVPHDTYGIPVYTVLWNLINYPACVIPFGQANKVEDAAYNRDVSYVPDYRPEEIEGAPCHIHLIGRPMADEKLVQDAKTICTVMSDVS

SEQ ID NO: 26 - protein, 540 aa, Aspergillus niger
MAVEQWETIVQKKQADAAAKIPQAWRLPAEFTAHVSETASTNVLDVPRKCGLLSAKQLEITENYDATALLEQIHSGKLTAVEVAEAFCLRAAIAQQVTRCLTETFFDLALERAKELDEYFQSTGKVRGPLHGLPISLKDCFNVAGVPNTIGFTAFIAHGPVKNNSSVVQILLDLGAVLYVKTNIPQTMMAADSHNYVFGRTLNPNRTKLSAGGSSGGEGALIAMRGSILGVGTDIAGSIRIPGIFDGTYALRPSIHRIPYGGQTGSGRKGLAGIRPCAGPLATSVRDLGLFMKTVVDIDPWQYDSSTIFSTWRTAPPKETLRLGFILEDPHFPVHPPILNTLTRAVDALKAAGHEVINLTTPSIRDALLLGFRTFAMDPARTAFSHITKSGEPRIPALRTTDLPNADLPFEWAPHTLESLYDLNVQRETLCEQFRQLIVQNKIDAIIMPGYQGTAVAHDQVGWVPYTVLANVLDYPATIIPYRKADKADDAKYVRDVTYRPPYVADDVEGAPCCVQLMGRTMHEEELLRDTAIVARVLGK

SEQ ID NO: 27 - protein, 579 aa, Aspergillus niger
MLPPFDYFTYRRIRDLKRRERAARFASLSPDYHAPFSAIDRVIINKPIQDLVYEVQNDSLAPLDVLRTYGKVAVKAHEKTNCVTELLLPEAESWAQSEVNLKGPLAGVPISLKDSVQVKGFDITLGYTKFACKPYKEDGPMAKLLKDAGAVPYAKTALPVTLLSFESANALWGHCLNPHVPEYSPGGSTGGEGALLALGGRIGIGSDVAGSVRVPAAWSGIYSLRCSTGRWPKVGVNTSMAGQEGVASVFSPMARTLNDLTYFTKAIVGMKPWNYDHTVHPISWREDEEIEAQNKRLRIGLMSNDGVVPPTPAIERAISTTVAALTAAGHTVSEITPPAAADTFTGLSLASQLLNSDGCVTFNSHLHSFEPSDPGADQLTRICNLPRPLRYLYYLWVRYIRRDEKWATLIRGFAPKSAAELWKLTAQREAFRATWHSWWDAETQQYDFILCPVNATPALPHKAMHDAVSSCGYTFLWNLLDYTAGVVPVSHVDAKKDALSGPYKKVLKQLGASNAVAYGAWKHYDAAKMAGLPTAVQVVGRRWQEEKVLGYMAAVEEALEQYQDPVTGEGGKYPLIELD

SEQ ID NO: 28 - protein, 529 aa, Aspergillus niger
MSVLFTSISPDNPVKREDAASLLRNLDLHIDQEDEEDFHTLLAAVHDCAETVANLPDYQPVPDLDRYPRHNVHRPSSEEQVFGQAWAHKFLIKGNPEGGLLTGKTISVKDCIAVAGVPQLLGSDIIPSWTPITDATVVTRVLDAGADIHGTSTCENYCHSTASFTSAQGTVENPFATGYSAGGSTSGGAALVAAGLVDITLGGDQGGSIRVPSAFCGCVGLKPTYGLVPFSGIASGDAIDDHTGPLARNVIDVASCLDAIAGYDGIDDRCLGSPKHGSTSFAKSLQADATRLDGFKIGVLKEGFEHTAVDPAVKESVMAATQKFAELGATVEEVSLPDHYHGPAIWTIQQRVSGSLTLLGQAHGRRGLYMTEMERERLPWTKEGFQRAFPATKNVIINGLYLTSRFPDLYGKSVNIGRRLRDLYEDLLQEYDVVVMPTTPVVAPRHGARGLPVESLKPSMGLTINTAIFDVTGHPAMSIPVGYAPAKDDPQVKLPVGMQIVGGLWQEFKVLKAGYAWEKNYDWKEVASH

SEQ ID NO: 29 - protein, 475 aa, Aspergillus niger
MARIDLSELTIAKVHTAFRRGDYSAVDLVQAYLRRIDQVNPRLNAILAINPNAVQEAQALDDAFRASRTLRPLHGVPVLVKDNIFTTAMPTTYGSKVAASRPVLPLDDAQVIKQLQGAGAIILAKTTLPDWATDFFSASTVSTWTQNPYDLARDPGGSSSGTAAGIAANLALVGVGTDTGGSIRLPSSFCSLVGMRPTVGLTSLDGVSPFVGCQDTVGPMCRTVTDAARLLDTLVLPTSPQSLAPSGGSYAAHLLPDSLPGPVCLGHLPQLGAEEAAVEALFTQVLTRLRGHASVTVRDLDIPSLSSTLAAASIMLSRGQHDLDDFLRTTVGTSLKTIYRDHAYPPTNFGIPGVATHASTLTDRSTASNARDALDRIITAHLGQAGVEVLVFLTAGRAAPRQEDITPEMGVTFPVHAMLASTLQWPAISVPIGFTATGLPVGLEILGRPLSDQRLLEVAFVIEQIVQGRRPPTVD

SEQ ID NO: 30 - protein, 605 aa, Aspergillus niger
MDEKPQFFQYPEARPGPAVPYKNEEQVIPVIRGFPLALGATLVQNIGFIQSHLWGTTGFDVIRNLPLDQYSARYDPTVIPVARPDASAADLPVPTQKRQSNAGYYTSADYVARYTSGELTPLAVVETLLPLIRRDAKPPGKHSIAFLESQVDKIRAAAEASTQRYKDGKPLGPMDGIPVAIKDEVHMEGYRRTLGSKLDFTGEFRGTSWCVKQWEEAGAIVIGKTIMHELGLDTTNNNPNFGTPRNPHNPDYYCGGSSGGSGYAVGAGLVPIALGADGGGSIRIPASFCGVWGLKPSHGRVSGSPTVSLASTTGVYGPLASSIDDLALAYRIMATPAPESSDPLSAAFPSPLRTLPSPTNNTPRTIGIVRDWIDRASPPVRAVFNATLDHYRTLKNYTIIDITIPYLPEGQKAHALTILSEVTSSLTPSQISQLTPANKIMASMGMWQIKGQDFLAAQRLRNCLMMHLAHLFQKHPGLMIVTPTTPIPGWKIEGGEADLKRGVSDGNTTVRNMEYVWLANFTGCPAISCPAGYDVLDGGSRVPVGVMAMGEWGSEEELIAFARDGEGVLDGTAAADGMEQSSGLTVPRGERAAWEDVIAKAGERR

SEQ ID NO: 31 - protein, 504 aa, Aspergillus niger
MSLLREAEKCLANQGSHAALNALITTLHQSGQWLERVRDADARRTRGTPKSEIDGRLVAVKDNMCTRDLPTTCASNALDKFVSPFNATVVQQLEDAGAVVAGKANLDEFGMGSHSIHSNFGPVRSSRRGQDAEYLSAGGSSGGSAVAVATAQCYAALGTDTGGSVRLPAAYTGTVGFKPSYGLVSRWGVVAYANSLDTVGVLGRDVASVRHVFGVVNQHDSRDPTNLSPSSRSRIDSHLKMSALASRTSSPLRIGVPLEYNISELSPSARHAWSRSLAYLQRQGHSIQTVSLPTTKLALSAYYVLAPAEASSNLAKYDGVRYGSRPEAPDGNASSERYLYAKTRGDGFGSEVKRRILLGAFSLSADAMDNYFIQAQRVRRLVQHDFNAAFRACQPLISSQLGSKSGSADTGVDVLICPTAPSSPPRISSLIGPDATTSPLEAYTNDVFTVPASLAGLPAISVPVTTENADGAEDGDLAGIQVIGQYGDDELVLKVAELLEGRHL

SEQ ID NO: 32 - protein, 636 aa, Aspergillus niger
MVRATQLAVAALGLLGAAAAQLVSTGMSVTLDQIDYFVSPYPAGNVTVSAASLTDIPSVNGFYPVTVVQEETAGVSSLSSLFSTWTDVDDVFTPAFLGAVLVRGYKPDNVTATFFNSSRSSVLSPLESRVVPSGPYFLEQATGNLYPVYRLYSDYAGAFTQPLLQKPDGTFQPLSAQVAGLVSSTIGVPSRIYYTPSDEKPLAGARVGVKDIYSLAGVRQSNGNRAWYNLYGENNVTGTAVSRLIDAGAIIVGLQKPSQFANGETATADWVDLHSPFNPRGDGYQDPSSSSSGAGASIGSYEWLDLALGSDTGGSIRNPAEVQGVYGSRPSHGLVELDHVMSMSPVLDTAGVLTRDPYLWDRANQALYSTNYTSFHGKSVRYPSKLYTIDFPTTNDSAADALLAGFQKRLAAFLNTTTTPLDLSDDWSSHPPSSAPANVSLETLLNLTYPMLITKQQIPLVRDPFYADYAAKHDGRVPFVDPVPLSRWNWSMAYPDSALDEAIHNKTLFMDWIAENYLTPISDPEQCSSSLIVYVGTDGSQRARNVYRSLPGAPSGYSKFLISNMASVPDFVIPVGEIEAYSTITQHQEKFPVAIDVLAAKGCDGLLVRLAQDLFEAGIINAPLAGGTLTGGPVLS

SEQ ID NO: 33 - protein, 564 aa, Aspergillus niger
MALTSWEQTAAAKRQSVLNAIPEKWRIKGPIPAPSEQRDVTGPYIQQFLSPREVEITETDAVGITERTTTGQWTAVEVTEAFCHRAALAHQLVNCLHEIFFDAALETARILDDHYTKTGKPLGPLHGLPVSLKDQFHVKGVETTMGYVGWINTFQGKTNDPRYLTHESELVKELRAAGAVLYCKTSVPMTLMSGETMNNIITYTHNPKNRLLSSGGSSGGEGALIALRGSPAGFGTDIGGSIRVPASFNGLYGIRPSVGRMPYEGAANSGDGQNTVLSVVGPLSPSARGLILLFKTVLGAMPWLGDPGVLEIPWREEIVEETRKLVQGKPEGLAFGIFYDDGQVKPQPPVERAMRIAAETIKRLGHKLINWEPPSHLTAASLANRAYNMDGGADVLQNFALSNEAIHTSVVIDASGSPQKTALEIAALNVEKREYQKQYLDYWNSTAQLTGTGRPVDAVICPVAPHAACIPGKYATIGYTAFINVLDYTSAVVPVTSADRRVDVVGKEGREYFGELDRKTEGEYDADVFDGAPAGIQLFGRRLQEEKILVLAEYLGEEFKKASA

SEQ ID NO: 34 - DNA, 46 bp, Artificial Sequence
  primer
cccttaattaactcataggcatcatggacgagaagcctcagttctt

SEQ ID NO: 35 - DNA, 33 bp, Artificial Sequence
  primer
ttaggcgcgccaattagagtgaccacaaatccc

SEQ ID NO: 36 - DNA, 44 bp, Artificial Sequence
  primer
cccttaattaactcataggcatcatggctcgtatcgatttgtcc

SEQ ID NO: 37 - DNA, 31 bp, Artificial Sequence
  primer
ttaggcgcgccgagaccgactagcccgtgaa

SEQ ID NO: 38 - DNA, 46 bp, Artificial Sequence
  primer
cccttaattaactcataggcatcatgtcggtattgttcacttctat

SEQ ID NO: 39 - DNA, 31 bp, Artificial Sequence
  primer
ttaggcgcgccgcatgccgtccaagttaccc

SEQ ID NO: 40 - DNA, 43 bp, Artificial Sequence
  primer
cccttaattaactcataggcatcatggtgcgcgctacccaact

SEQ ID NO: 41 - DNA, 33 bp, Artificial Sequence
  primer
ttaggcgcgcccgtcaaataccaatcgtatgtg

(19) United States
(12) Patent Application Publication
(10) Pub. No.: US 2008/0008780 A1
(43) Pub. Date: Jan. 10, 2008

(54) Amidases from Aspergillus Niger and Their Use in a Food Production Process

(76) Inventor: Hugo Streekstra, Amsterdam (NL)

Correspondence Address: NIXON & VANDERHYE, PC, 901 NORTH GLEBE ROAD, 11TH FLOOR, ARLINGTON, VA, 22203, US

(21) Appl. No.: 11/664,419

(22) PCT Filed: Oct. 13, 2005
(86) PCT No.: PCT/EP05/55242

§ 371 Date: Apr. 2, 2007

(30) Foreign Application Priority Data
Oct. 15, 2004 (EP) 04105077.4
Dec. 29, 2004 (EP) 04107053.3
Jul. 7, 2005 (EP) 05106200.8

(51) Int. Cl. A23L 1/20

(52) U.S. Cl. 426/46

(57) ABSTRACT

Process for the production of a food or feed product, comprising a heating step followed by adding an enzyme to an intermediate form of the food or feed product, whereby the enzyme is capable of lowering the acrylamide level of the food or feed product. The invention also relates to food or feed products obtained by the process of the invention.

### FIELD OF THE INVENTION

The present invention relates to processes for the production of a food, pet food, or feed product involving at least one heating step, and to food, pet food, or feed products obtained by such a process. Furthermore, the present invention relates to a novel enzymes suitable for the process according to the invention.

Acrylamide has been produced commercially for a number of years. Hence, its toxicological status is well evaluated. Acrylamide is mainly used for the production of poly-acrylamide, and the latter compound is used for various applications, such as the production of drinking water, soil stabilization, industrial wastewater treatment, the winning of oil, and laboratory applications.

Acrylamide is considered as probably carcinogenic for animals and humans. In 1991, the Scientific Committee on Food investigated monomeric acrylamide in contact food materials, and it concluded that acrylamide is a genotoxic carcinogen. Bergmark et al. (Chem. Res. Toxicol. 10: 78-84, 1997) demonstrated that acrylamide is a component in tobacco smoke. This was the first link between the formation of acrylamide and the heating of biological material. Recently, the occurrence of acrylamide in a number of fried and oven-prepared foods was reported (Tareke et al., Chem. Res. Toxicol. 13: 517-522, 2000), causing worldwide concern. Further research revealed that considerable amounts of acrylamide are detectable in a variety of baked, fried and oven-prepared common foods, and it was demonstrated that the occurrence of acrylamide in food was a result of the heating process.

The official limit for acrylamide contamination in food products in the UK has been set at 10 ppb (10 micrograms per kilogram). The values reported in the literature exceed this value in many products, for instance cereals, bread products, coffee, potato chips (French fries), and potato crisps.

A relation between the administered dose of acrylamide and tumour incidence was found in tests in which rats—whose fate was followed for two years—were fed acrylamide via drinking water (Friedman et. al., Fundam. Appl. Pharmacol. 85:154-168, 1986; Johnson et. al., Toxicol. Appl. Pharmacol. 85: 154-168, 1986). Tareke et. al. investigated haemoglobin-bound acrylamide in rats—as N-(2-carbamoylethyl)-valine—in relation to an acrylamide-containing diet. Combining these data, it was calculated that a daily uptake of acrylamide of 1.6 mg/kg corresponds to a cancer risk of 7*10⁻³ for humans from life-long exposure.

A pathway for the formation of acrylamide from amino acids and reducing sugars has been proposed (Mottram et al., Nature 419: 448, 2002). According to this hypothesis, acrylamide is formed during the Maillard reaction. During baking, frying and roasting, Maillard reactions contribute strongly to the colour, smell and taste of the product. Associated with the Maillard reactions is the Strecker degradation of amino acids, and a pathway towards acrylamide was proposed. The formation of acrylamide became detectable when the temperature exceeded 120° C., and the highest formation rate was observed at around 170° C. When both asparagine and glucose were present, the highest levels of acrylamide were observed, while glutamine and aspartic acid only gave rise to trace quantities.

In the interest of public health, there is an urgent need for food products that have substantially lower levels of acrylamide or, preferably, are devoid of it. In first instance, research activities have been initiated in order to unravel the mechanism of acrylamide formation in food products. So far, the results have not yet led to a satisfactory solution of the problem. Currently, food companies are investigating the possibilities to avoid the formation of acrylamide by lowering the temperature of the oven cooking and roasting processes. However, such adaptations will inherently result in food products with altered taste properties (less Maillard products), or with an altered composition (higher fat content).

Patent applications US 2004/0058046 and US 2004/0058054 provide methods to prevent acrylamide formation by treatment of an intermediate form of a food product with an enzyme that breaks down amino acids involved in the formation of acrylamide, in particular asparagine. The modification of amino acids may be undesirable in view of the product's quality, for instance when the relevant amino acids represent a major fraction of the product's mass. This is for example the case for potatoes wherein about 0.1 wt % asparagine is present with respect to the potatoes dry weight. The acrylamide formed on potato chips is about 100 ppb, indicating that only a small fraction of the asparagine present in the potato is formed into acrylamide. Applying the methods according to the above-mentioned patent applications, however, would result in the need to modify all or at least the majority of the nutritional relevant amino acid asparagine present.

Furthermore, in certain cases this method is difficult to apply, for instance when none of the intermediate forms of the food product, that occur prior to the heating step, contains sufficient moisture to allow an externally supplied enzyme to act. Finally, it may be that acrylamide is formed in spite of all measures taken to avoid this.

It is the objective of the present invention to provide a novel food production process capable of lowering the acrylamide level in the food product, the process being suitable for being used on a food product or its intermediate or its raw materials, whilst maintaining a high level of nutritionally relevant amino acids.

The objective of the present invention is reached by a food production process comprising the steps of:
heating a food product to a temperature at which acrylamide is formed,
followed by adding an enzyme, said enzyme being capable of modifying acrylamide.

Surprisingly, it is possible to apply an enzyme capable of modifying acrylamide to food and obtain the desired low levels of acrylamide, while maintaining a high level of nutritionally relevant amino acids, for example asparagine.

The wording “food” is here and hereafter defined to include both foodstuffs for human consumption and foodstuffs for animal consumption, including pet food and feed, unless explicitly specified differently in the description. Food includes beverages. Furthermore, the wording “food product” is defined to cover raw material, food intermediates and food products being ready for consumption, unless explicitly specified differently in the description. The present invention provides a process for the production of a food product involving at least one heating step, comprising adding an enzyme capable to modify acrylamide after said heating step. The form of the food product to which the enzyme is applied does not have to be the final product—additional processing steps may take place after the addition of the enzyme. The preferred food products are food products that are heat treated in dried condition and therefore contain an amount of acryl amide to be reduced to lower levels. By dried condition is meant comprising less than 20 wt %, preferably less than 15 wt %. Coffee beans, coffee powder, coffee drinks, or coffee containing drink is the most preferred food to be treated. Coffee beans are ‘roasted’ in dry condition to get their aroma. During this roasting or heat treatment, acryl amide will be formed.

These beans are very difficult to pretreat with for example an asparaginase to prevent acrylamide formation. WO 2004/037007 discloses such a pre treatment.

In WO 2004/037007 acrylamide forming was tried to be solved by bringing an exogenously added enzyme in contact with a compound inside a more-or-less solid matrix.

The methods in WO 2004/037007 need further substantial additional processing, involving, drying, hydration, reducing the particle size, etc. prior to the roasting step. This is in general not compatible with coffee processing.

The methods employed are quite laboreous and time-consuming, and the reduction in acrylamide is modest.

Moreover, soaking with inactivated enzyme is also effective (see Example 3 of WO 2004/037007), so at least part of the effect is simply due to the aqueous extraction of asparagine from the coffee beans, and not due to the enzyme activity. With this extraction also valuable coffee aroma compounds will be lossed.

In the process of the invention heating steps are those in which a part of the intermediate food product is exposed to temperatures at which the formation of acrylamide is promoted, e.g. 105° C. or higher, 120° C. or higher. Generally, the temperature of the heating step in a food production process is maximally 250° C., more generally up to 220° C. or 200° C. The heating step in the process according to the invention may be carried out in ovens, for instance at a temperature between 150-250° C., such as for the baking of bread and other baked products; in oil such as the frying of French fries, potato crisps, or tofu, for example at 150-200° C.; on a hotplate or on or under a heated grill.

Preferred heating steps are roasting or grilling.

The food product may be made from at least one raw material that is of plant origin, for example tubers such as potato, sweet potato, or cassava; legumes, such as peas or soy beans; aromatic plants, such as tobacco, coffee or cocoa; nuts; or cereals, such as wheat, rye, corn, maize, barley, groats, buckwheat, rice, or oats. Also food products made from more than one raw material are included in the scope of this invention, for example food products comprising both corn and potato.

The food product may also comprise at least one raw material that is of animal origin.

The food product may also comprise at least one raw material that is of fungal origin, such as raw materials derived from mushrooms or fungal protein.

An example of food products in which the process according to the invention can be suitable, are roasted products, and/or powders, mixtures, and/or extracts made from roasted products. Examples of roasted products are: coffee or cocoa beans; nuts, such as peanuts, almonds, walnuts, pecan nuts, hazelnuts; cereals, such as roasted corn; roots, such as chicory; isolated substances, such as sugar used for caramel. The process according to the invention is particularly suitable for coffee or cocoa beans.

The present invention also relates to products derived from roasted materials. Examples of products derived from roasted materials, are brewed coffee, coffee extract, coffee concentrate instant coffee, liquid coffee drinks, ground coffee, the decaf version of these coffee products, cocoa powder, chocolate, instant chocolate drink, nut paste, beer, whisky, malt, malt extract, soy sauce.

The present invention is extremely suitable for roasted food products, since in the production of these products generally no step is included comprising sufficient moisture to allow enzyme action on the product intermediates prior to the heating step.

Particularly preferred processes are those that involve a liquid or moist environment after the heating step, such as the liquid extraction of roasted or heated materials or mixing of ground roasted or heated materials with another, moist material or with moisture. Examples of products made with such processes are coffee, cocoa drink, chocolate, almond spice, soy sauce and caramel.

Without prejudice to the processes as described above, the process according to the invention can also be used to other food products comprising acrylamide.

Acrylamide is formed in food by the reaction of asparagine and glucose when the food is heated at temperatures of 100-120 degrees Celcius and higher. The acrylamide formation will increase with increasing temperatures. Several foods are treated at temperatures whereby acrylamide will be formed such as baked bread in an oven of 225 degrees Celcius, French fries when fried in oil of about 160 to 180 degrees Celcius or coffee beans roasted at temperatures of 180° C. and higher.

In several patent applications the possibility is described to prevent the formation of acrylamide. An example hereof is the enzymatic treatment of asparagines using asparaginases. This treatment was shown to be very successful. For example in bread, French fries and chips the amount of acrylamide formed was substantially reduced. In these cases the enzyme was added to the food before heating. The enzyme was added to the dough before baking. French fries or chips could be sprayed with an enzyme solution. For French fries and bread, only the outer surface of the food will be exposed to a temperature above 100 degrees Celcius. In bread the inner part will not be heated above 80 or 90 degrees Celcius because of the presence of water. Also the inner part of French fries will not be heated above the boiling temperature of water and in the inner part substantially no acrylamide will be formed and thus only the enzymatic treatment of the outer surface of the French fries is enough to prevent acrylamide formation.

We have found that the use of this asparinases is less effective in food products which will be heat treated in such away that the whole food product will have a temperature of above 120 degrees Celcius and whereby there are no methods to incorporate the enzyme in the whole food product in a commercially attractive way. In general these food products are solid and not kneadable (thus not like a bread dough), have a thickness of at least 3 mm, and contain only minor amounts of water, in general less than 20 wt %, preferably less than 12 wt % of water. A good example hereof are coffee beans. These beans are roasted to produce coffee beans suitable for making coffee. During roasting the whole bean will have a temperature of more than 150 degrees Celcius. Acrylamide will not be only formed in the outer layer, like in case of French fries or bread, but acrylamide is also formed throughout the whole bean.

In the most common process, coffee berries are picked, dehulled, matured (“fermented”), washed, and dried (either to the open air or by forced hot air). These steps take at the coffee producer (in the producing country). The resulting product is the green coffee bean, with a moisture content between 9.8 and 12.5% (the recommendation is 11-12). In this stage the bean is well-keepable.

For “normal” coffee, the beans are simply roasted. Small equipment is operated at about 260° C. (temperature inside becomes higher than 200° C.). Industrial equipment probably uses higher air temperatures (but shorter residence times).

The present invention therefore is preferably used in the process of producing food which is a coffee product preferably coffee beans, ground coffee, instant coffee, liquid coffee drinks, coffee extracts and the decaf version of coffee products.

For decaf there are at least 4 processes (all run on the green coffee beans):

1. Supercritical extraction with CO2. Here the enzyme cannot act.

2. Methylene-chloride extraction. Here the beans are steamed first.

3. Ethyl-acetate extraction. Here the caffeine is water-extracted from the beans (along with a lot of other (aroma) compounds), then the caffeine is removed with ethyl-acetate, and the wash water is added back to the beans to give back the flavor.

4. Swiss water process. This resembles 3, but with active carbon absorption instead of the ethyl acetate.

Although the present invention can be applied in all decaf producing processes, the process of the present invention is most advantageously applied in making regular coffee products.

We have been surprisingly found that the amount of acrylamide can be reduced in coffee by not treating the coffee beans but rather extracts made of these coffee beans.

Therefore the present invention discloses a process to reduce the level of acrylamide in food by treating food which has been heat treated at temperatures above 100 degrees Celcius, preferably above 120 degrees Celcius and most preferably above 150 degrees Celcius and subsequently is contacted under aqueous conditions with an amidase enzyme.

Preferable the aqueous conditions are obtained by adding a liquid or paste containing water. The liquid or paste may contain the enzyme but the liquid or paste may also be added separately from the enzyme. After the addition of the liquid or paste, the food product may be in aqueous state (for example coffee extract or chocolate or cocoa drink), in an paste state (for example peanut butter or almond spice), in an emulsion form (for example peanut butter) as long as the enzymatically treated food contains at least 15 wt %, preferably at least 25 wt %, more preferably at least 40 wt % and most preferably at least 60 wt % of water. The food product of the present invention is preferably a brewed coffee, liquid coffee drinks, coffee extracts, cocoa drinks or chocolate drinks. After the enzymatical treatment, the food product may be dried or partially dried. So also concentrated coffee extract, instant coffee, instant chocolate drink or instant cocoa drinks with were enzymatically treated with an amidase are part of the present invention.

If necessary the amidase can be inactivated. This can be done by for example a short heat treatment at a suitable temperature for example at 90° C.

We were the first ones who succeeded making coffee from coffee beans or coffee powder that comprises less than 50 ppb, preferably less than 30 ppb and most preferably less than 10 ppb acrylamide (micrograms acrylamide/kg dry coffee) on an industrial scale.

Therefore the present invention provides roasted coffee beans, coffee extracts, concentrated coffee drinks, coffee drinks, brewed coffee containing less than 50 ppb, preferably less than 30 ppb and most preferably less than 10 ppb of acrylamide based on dry matter coffee.

The present invention also comprises packages such as sealed foil packages, optionally vacuum sealed, jars or pots made of metal, glass or polymers and the like which comprise at least 50 grams, preferably at least 100 grams of roasted coffee beans, coffee extracts, concentrated coffee drinks, coffee drinks, brewed coffee containing less than 50 ppb, preferably less than 30 ppb and most preferably less than 10 ppb of acrylamide based on dry matter coffee.st preferably less than 10 ppb of acrylamide based on dry matter coffee.

In general these packages will contain less than 1000 kg, preferably less than 100 kg, more preferably less than 10 kg and most preferably less than 1 kg of roasted coffee beans, coffee extracts, concentrated coffee drinks, coffee drinks, brewed coffee containing less than 50 ppb, preferably less than 30 ppb and most preferably less than 10 ppb of acrylamide based on dry matter coffee.st preferably less than 10 ppb of acrylamide based on dry matter coffee.

The enzyme used in the process of the invention is an enzyme capable of modifying acrylamide. By “enzyme” is meant “one enzyme” as well as “a combination of more than one enzyme”. Preferably, the enzyme is capable of modifying short-chain non-cyclic amides. Generally short chain non-cyclic amides comprise at most 6 C-atoms in their aliphatic chain, more preferably at most 5, even more preferably at most 4 and most preferably at most 3. The aliphatic chain can be linear or branched. More preferably, the enzyme is capable of modifying acrylamide, acetamide and/or propionamide. A preferred modification of acrylamide is through the action of an amidase.

Preferably, the enzyme preparation used in the process of the invention is derived from a micro-organism and obtained by fermentation processes known in the art. The micro-organism may be a bacterium, a fungus or a yeast.

The enzyme can be obtained from various sources, such as for example from plants, animals and microorganisms, such as for example Alcaligenes, Arthrobacter, Brevibacterium, Escherichia, Klebsiella, Mycobacterium, Streptomyces, Saccharomyces, Pseudomonas, Rhodococcus, Xanthomonas, Aspergillus and Bacillus species, preferably Aspergillus, Baccillus or Saccharomyces, more preferably Aspergillus. An example of a suitable Escherichia strain is Escherichia coli. An example of a suitable Rhodococcus strain is Rhodococcus rhodochrous. Examples of suitable Pseudomonas strains are P. aeruginosa, P. cepacia, and P. chloroapis. An example of suitable Streptomyces strains is Streptomyces lividans. Examples of suitable Saccharomyces strains are for example Saccharomyces cerevisae, Saccharomyces uvarum, Saccharomyces bayanus, Saccharomyces pastorianus or Saccharomyces paradoxus. Examples of suitable Aspergillus strains are Aspergillus oryzae, Aspergillus nidulans (Emericella nidulans) or Aspergillus niger. Examples of suitable Bacillus strains are Bacillus alkalophilus, Bacillus amyloliquefaciens, Bacillus brevis, Bacillus circulans, Bacillus coagulans, Bacillus lautus, Bacillus lentus, Bacillus licheniformis, Bacillus megateruim, Bacillus stearothemophilus, Bacillus subtilis or Bacillus thuringiensis.

Preferably, the enzyme is obtained from food-grade organisms, for example Aspergillus niger, Saccharomyces cerevisiae, or Bacillus subtilis, most preferably Aspergillus niger.

Preferably the enzyme is provided in a stabile form, usually a liquid, a powder, a granulate, or an encapsulated form. Irrespective of the formulation of the enzyme, any additives and stabilizers known to be useful in the art to improve and/or maintain the enzyme's activity may be applied. When the enzyme is contained in a liquid form, it may be applied to the product by any conceivable method, for instance by soaking, spraying or mixing. The enzyme can for example also be added to a liquid extract, an emulsion or a suspension of an intermediate of the food. Alternatively, the enzyme can be produced in situ by a micro-organism capable of producing said enzyme.

The enzyme can be added in an amount of about at between 100-0.1 U/L, more preferably lower than 50 U/L, even more preferably at most 10 U/L or between 5 and 1 U/L (wherein 1 U is defined as hydrolysing 1 μmol amide per minute), see Example 8.

Amidases (or amidohydrolases) are enzymes that hydrolyse the C—N chemical bond of an amide, thereby producing ammonia and the corresponding acid. For instance an acetamidase converts acetamide to ammonia and acetic acid, and an acrylamidase converts acrylamide to ammonia and acrylic acid (propenoic acid).

Amidases are a well-researched class of enzymes, classified as “Enzymes hydrolysing carbon-nitrogen bonds, other than peptide bonds” (EC 3.5). Of particular interest is the group acting on linear amides (3.5.1). Another group of enzymes that catalyse a similar reaction are the beta-lactam acylases (EC 3.5.1.11), where the C and the N are also both substituted, for instance glutaryl acylase, where the C is part of glutaric acid, and the N part of a beta-lactam ring. Additional enzymes that act in a similar fashion are asparaginase (3.5.1.1), glutaminase (3.5.1.2), 6-aminohexanoate-cyclic-dimer hydrolase (EC 3.5.2.12), fatty acid amide hydrolase, chitin deacetylase (3.5.1.41), glutamyl-tRNA (Gln)-amidotransferase. The hydrolytic reaction that they catalyse is similar to that for peptidases (EC 3.4), but in the case of peptidases both the C and the N of the hydrolysed bond are contained in amino acids.

Note that the use of the amidases according to the invention, being to modify acrylamide once it is formed, is essentially different from the use of for example asparaginase to break down amino acids in order to prevent the formation of acrylamide as is described in the prior art, for example US 2004/0058046 or US 2004/0058054.

Many, but not all, of these enzymes share a common structural motif: a conserved region rich in glycine, serine, and alanine residues. It has been reported that there are three major families of amidases: the amidase signature group (examples: A. oryzae, S. typhimurium); the nitrilase group (examples: P. aeruginosa, R. erythropolis, H. pylori, B. stearothermophilus); the urease group (example: M. smegmatis) (Novo, et al., Biochem. J. 365: 731-738, 2002). Substrates for amidases include acetamide, indoleacetamide, phenylacetamide, para-nitro-phenylacetamide, para-nitro-acetanilide, chloracetamide, propionamide, butyramide, isobutyramide, succinamide, acrylamide, methacrylamide, benzamide, and nicotinamide.

The use of amidases from various sources to hydrolyse acrylamide has been reported in the prior art for removal of monomeric acrylamide from polyacrylamide products, to allow for a safer application on the polymer. For example, U.S. Pat. No. 4,925,797 describes the use of an amidase from Methylophilus methylotrophus for this purpose. The authors of this patent are concerned with the presence of acrylamide in polymers that may come into contact with food, and they provide a method to remove the acrylamide from the polymer to avoid contamination of the food. In U.S. Pat. No. 5,962,284, amidase from Rhodococcus sp. is used to decrease acrylamide levels in polyacrylamide gels. U.S. Pat. No. 6,248,551 describes acrylamidase from Helicobacter pylori. Other authors have used immobilized cells to achieve the breakdown of acrylamide, for instance in U.S. Pat. No. 6,146,861 where Rhodococcus rhodochrous cells are used for this purpose.

These applications are not directed to food itself comprising acrylamide, nor indicate the use of these amidases onto food products itself in order to decrease acrylamide levels let alone indicate the suitability of amidases for food applications.

The above applications are furthermore directed to use of bacterial amidases. However, acrylamide hydrolysing activities are also known from fungi. The Emericella acetamidase is applied as a selection marker for genetically transformed fungal cells in the field of molecular genetics. However, compared to the knowledge on substrate ranges, specificities, and preferences of the bacterial amidases, little is known about the properties of the fungal enzymes. Also, fungal amidases have not been employed for the effective removal of acrylamide. Moreover, successful application of acrylamide-hydrolysing enzymes in food, successful in the sense that acrylamide is reduced to acceptable levels, has not yet been achieved. This is not a trivial point, since the levels to be achieved—and hence the concentration of the enzyme substrate, are extremely low, being in the ppb range, such as lower than 200 ppb, more preferably lower than 100 ppb, even more preferably lower than 50 ppb and most preferably lower than 20 ppb.

Surprisingly, we have found that the filamentous fungus Aspergillus niger harbours multiple genes coding for enzymes that are able to hydrolyse acrylamide. Moreover we have found some of these enzymes to be secreted into the culture liquid, which improves the ease of producing and isolating these. Moreover, we have found that some of these enzymes are capable of effectively removing acrylamide from foodstuffs, in particular from foodstuffs where acrylamide has been formed during a heating step.

In a second aspect, the invention provides newly identified polynucleotide sequences comprising genes that encode novel amidases which for example can be yielded from Aspergillus niger. The novel amidases can be used in the process for food production of the present invention, for example in production of coffee extract.

### Polynucleotides

The invention also provides for novel polynucleotides encoding novel amidase enzymes. The present invention provides novel polynucleotides encoding an amidase, tentatively called AMID01, AMID02, AMID03, AMID04, AMID05, AMID06, AMID07, AMID08, AMID09, AMID10 and AMID11 (hereinafter referred to AMID01-11), having an amino acid sequence chosen from the group respectively consisting of SEQ ID NO: 23, 24, 25, 26, 27, 28, 29, 30, 31, 32 and 33 (hereinafter referred to SEQ ID NO: 23-33) or functional equivalents of any of them. The sequence of the genes encoding AMID01-11 was determined by sequencing a genomic clone obtained from Aspergillus niger. The invention provides polynucleotide sequences comprising the gene encoding the AMID01-11 amidase as well as its complete cDNA sequence and its coding sequence. Accordingly, the invention relates to an isolated polynucleotide comprising the nucleotide sequence chosen from the group consisting of SEQ ID NO: 1, 2, 3, 4, 5, 6, 7, 8, 9, 10 or 11 (hereinafter referred to as SEQ ID NO: 1-11) or chosen from the group consisting of SEQ ID NO: 12, 13, 14, 15, 16, 17, 18, 19, 20, 21 or 22 (hereinafter referred to as SEQ ID NO: 12-22) or functional equivalents of any of them.

More in particular, the invention relates to an isolated polynucleotide hybridisable, preferably under stringent conditions, more preferably under highly stringent conditions, to a polynucleotide chosen from the group consisting of SEQ ID NO: 1-11 or chosen from the group consisting of SEQ ID NO: 12-22. Advantageously, such polynucleotides may be obtained from filamentous fungi, in particular from Aspergillus niger. More specifically, the invention relates to an isolated polynucleotide having a nucleotide sequence chosen from the group consisting of SEQ ID NO: 1-11 or chosen from the group consisting of SEQ ID NO: 12-22.

The invention also relates to an isolated polynucleotide encoding at least one functional domain of a polypeptide chosen from the group consisting of SEQ ID NO: 23-33 or functional equivalents of any of them.

As used herein, the terms “gene” and “recombinant gene” refer to nucleic acid molecules which may be isolated from chromosomal DNA, which include an open reading frame encoding a protein, e.g. an A. niger asparaginase. A gene may include coding sequences, non-coding sequences, introns and regulatory sequences. Moreover, a gene refers to an isolated nucleic acid molecule as defined herein.

A nucleic acid molecule of the present invention, such as a nucleic acid molecule having the nucleotide sequence chosen from the group consisting of SEQ ID NO: 1-11 or chosen from the group consisting of SEQ ID NO: 12-22 or a functional equivalent of any of them, can be isolated using standard molecular biology techniques and the sequence information provided herein. For example, using all or portion of the nucleic acid sequence chosen from the group consisting of SEQ ID NO: 1-11 or chosen from the group consisting of SEQ ID NO: 12-22 as a hybridization probe, nucleic acid molecules according to the invention can be isolated using standard hybridization and cloning techniques (e.g., as described in Sambrook, J., Fritsh, E. F., and Maniatis, T. Molecular Cloning: A Laboratory Manual. 2nd, ed., Cold Spring Harbor Laboratory, Cold Spring Harbor Laboratory Press, Cold Spring Harbor, N.Y., 1989).

Moreover, a nucleic acid molecule encompassing all or a portion of a nucleic acid sequence chosen from the group consisting of SEQ ID NO: 1-11 or chosen from the group consisting of SEQ ID NO: 12-22 can be isolated by the polymerase chain reaction (PCR) using synthetic oligonucleotide primers designed based upon the sequence information contained in a sequence chosen from the group consisting of SEQ ID NO: 1-11 or chosen from the group consisting of SEQ ID NO: 12-22.

A nucleic acid of the invention can be amplified using cDNA, mRNA or alternatively, genomic DNA, as a template and appropriate oligonucleotide primers according to standard PCR amplification techniques. The nucleic acid so amplified can be cloned into an appropriate vector and characterized by DNA sequence analysis.

Furthermore, oligonucleotides corresponding to or hybridisable to nucleotide sequences according to the invention can be prepared by standard synthetic techniques, e.g., using an automated DNA synthesizer.

In a preferred embodiment, an isolated nucleic acid molecule of the invention comprises the nucleotide sequence chosen from the group consisting of SEQ ID NO: 12-22. The sequence chosen from the group consisting of SEQ ID NO: 12-22 correspond respectively to the coding region of the A. niger AMID01-11 cDNA. This cDNA comprises sequences encoding the A. niger AMID01-11 polypeptide respectively according to SEQ ID NO: 23-33.

In another preferred embodiment, an isolated nucleic acid molecule of the invention comprises a nucleic acid molecule which is a complement of the nucleotide sequence chosen from the group consisting of SEQ ID NO: 1-11 or chosen from the group consisting of SEQ ID NO: 12-22 or a functional equivalent of any of these nucleotide sequences.

A nucleic acid molecule which is complementary to another nucleotide sequence is one which is sufficiently complementary to the other nucleotide sequence such that it can hybridize to the other nucleotide sequence thereby forming a stable duplex.

One aspect of the invention pertains to isolated nucleic acid molecules that encode a polypeptide of the invention or a functional equivalent thereof such as a biologically active fragment or domain, as well as nucleic acid molecules sufficient for use as hybridisation probes to identify nucleic acid molecules encoding a polypeptide of the invention and fragments of such nucleic acid molecules suitable for use as PCR primers for the amplification or mutation of nucleic acid molecules.

An “isolated polynucleotide” or “isolated nucleic acid” is a DNA or RNA that is not immediately contiguous with both of the coding sequences with which it is immediately contiguous (one on the 5′ end and one on the 3′ end) in the naturally occurring genome of the organism from which it is derived. Thus, in one embodiment, an isolated nucleic acid includes some or all of the 5′ non-coding (e.g., promotor) sequences that are immediately contiguous to the coding sequence. The term therefore includes, for example, a recombinant DNA that is incorporated into a vector, into an autonomously replicating plasmid or virus, or into the genomic DNA of a prokaryote or eukaryote, or which exists as a separate molecule (e.g., a cDNA or a genomic DNA fragment produced by PCR or restriction endonuclease treatment) independent of other sequences. It also includes a recombinant DNA that is part of a hybrid gene encoding an additional polypeptide that is substantially free of cellular material, viral material, or culture medium (when produced by recombinant DNA techniques), or chemical precursors or other chemicals (when chemically synthesized). Moreover, an “isolated nucleic acid fragment” is a nucleic acid fragment that is not naturally occurring as a fragment and would not be found in the natural state.

As used herein, the terms “polynucleotide” or “nucleic acid molecule” are intended to include DNA molecules (e.g., cDNA or genomic DNA) and RNA molecules (e.g., mRNA) and analogs of the DNA or RNA generated using nucleotide analogs. The nucleic acid molecule can be single-stranded or double-stranded, but preferably is double-stranded DNA. The nucleic acid may be synthesized using oligonucleotide analogs or derivatives (e.g., inosine or phosphorothioate nucleotides). Such oligonucleotides can be used, for example, to prepare nucleic acids that have altered base-pairing abilities or increased resistance to nucleases.

Another embodiment of the invention provides an isolated nucleic acid molecule which is antisense to at least any one of the nucleic acid molecule chosen from the group consisting of AMID01-11, e.g. its coding strand. Also included within the scope of the invention are the complement strands of the nucleic acid molecules described herein.

### Sequencing Errors

The sequence information as provided herein should not be so narrowly construed as to require inclusion of erroneously identified bases. The specific sequences disclosed herein can be readily used to isolate the complete gene from filamentous fungi, in particular A. niger which in turn can easily be subjected to further sequence analyses thereby identifying sequencing errors.

Unless otherwise indicated, all nucleotide sequences determined by sequencing a DNA molecule herein were determined using an automated DNA sequencer and all amino acid sequences of polypeptides encoded by DNA molecules determined herein were predicted by translation of a DNA sequence determined as above. Therefore, as is known in the art for any DNA sequence determined by this automated approach, any nucleotide sequence determined herein may contain some errors. Nucleotide sequences determined by automation are typically at least about 90% identical, more typically at least about 95% to at least about 99.9% identical to the actual nucleotide sequence of the sequenced DNA molecule. The actual sequence can be more precisely determined by other approaches including manual DNA sequencing methods well known in the art. As is also known in the art, a single insertion or deletion in a determined nucleotide sequence compared to the actual sequence will cause a frame shift in translation of the nucleotide sequence such that the predicted amino acid sequence encoded by a determined nucleotide sequence will be completely different from the amino acid sequence actually encoded by the sequenced DNA molecule, beginning at the point of such an insertion or deletion.

The person skilled in the art is capable of identifying such erroneously identified bases and knows how to correct for such errors.

### Nucleic Acid Fragments, Probes and Primers

A nucleic acid molecule according to the invention may comprise only a portion or a fragment of the nucleic acid sequence chosen from the group consisting of SEQ ID NO: 1-11 or chosen from the group consisting of SEQ ID NO: 12-22, for example a fragment which can be used as a probe or primer or a fragment encoding a portion of an AMID01-11 protein. The nucleotide sequence determined from the cloning of the AMID01-11 gene and cDNA allows for the generation of probes and primers designed for use in identifying and/or cloning other AMID01-11 family members, as well as AMID01-11 homologues from other species. The probe/primer typically comprises substantially purified oligonucleotide which typically comprises a region of nucleotide sequence that hybridizes preferably under highly stringent conditions to at least about 12 or 15, preferably about 18 or 20, preferably about 22 or 25, more preferably about 30, 35, 40, 45, 50, 55, 60, 65, or 75 or more consecutive nucleotides of a nucleotide sequence chosen from the group consisting of SEQ ID NO: 1-11 or chosen from the group consisting of SEQ ID NO: 12-22 or of a functional equivalent of any of them.

Probes based on the AMID01-11 nucleotide sequences can be used to detect transcripts or genomic AMID01-11 sequences encoding the same or homologous proteins for instance in other organisms. In preferred embodiments, the probe further comprises a label group attached thereto, e.g., the label group can be a radioisotope, a fluorescent compound, an enzyme, or an enzyme cofactor. Such probes can also be used as part of a diagnostic test kit for identifying cells which express an AMID01-11 protein.

### Identity & Homology

The terms “homology” or “percent identity” are used interchangeably herein. For the purpose of this invention, it is defined here that in order to determine the percent identity of two amino acid sequences or of two nucleic acid sequences, the sequences are aligned for optimal comparison purposes (e.g., gaps can be introduced in the sequence of a first amino acid or nucleic acid sequence for optimal alignment with a second amino or nucleic acid sequence). The amino acid residues or nucleotides at corresponding amino acid positions or nucleotide positions are then compared. When a position in the first sequence is occupied by the same amino acid residue or nucleotide as the corresponding position in the second sequence, then the molecules are identical at that position. The percent identity between the two sequences is a function of the number of identical positions shared by the sequences (i.e., % identity=number of identical positions/total number of positions (i.e. overlapping positions)×100). Preferably, the two sequences are the same length.

The skilled person will be aware of the fact that several different computer programs are available to determine the homology between two sequences. For instance, a comparison of sequences and determination of percent identity between two sequences can be accomplished using a mathematical algorithm. In a preferred embodiment, the percent identity between two amino acid sequences is determined using the Needleman and Wunsch (J. Mol. Biol. (48): 444-453 (1970)) algorithm which has been incorporated into the GAP program in the GCG software package (available at http://www.gcg.com), using either a Blossom 62 matrix or a PAM250 matrix, and a gap weight of 16, 14, 12, 10, 8, 6, or 4 and a length weight of 1, 2, 3, 4, 5, or 6. The skilled person will appreciate that all these different parameters will yield slightly different results but that the overall percentage identity of two sequences is not significantly altered when using different algorithms.

In yet another embodiment, the percent identity between two nucleotide sequences is determined using the GAP program in the GCG software package (available at http://www.gcg.com), using a NWSgapdna.CMP matrix and a gap weight of 40, 50, 60, 70, or 80 and a length weight of 1, 2, 3, 4, 5, or 6. In another embodiment, the percent identity two amino acid or nucleotide sequence is determined using the algorithm of E. Meyers and W. Miller (CABIOS, 4:11-17 (1989) which has been incorporated into the ALIGN program (version 2.0) (available at: http://vega.igh.cnrs.fr/bin/align-guess.cgi) using a PAM120 weight residue table, a gap length penalty of 12 and a gap penalty of 4.

The nucleic acid and protein sequences of the present invention can further be used as a “query sequence” to perform a search against public databases to, for example, identify other family members or related sequences. Such searches can be performed using the NBLAST and XBLAST programs (version 2.0) of Altschul, et al. (1990) J. Mol. Biol. 215:403-10. BLAST nucleotide searches can be performed with the NBLAST program, score=100, wordlength=12 to obtain nucleotide sequences homologous to AMID01-11 nucleic acid molecules of the invention. BLAST protein searches can be performed with the XBLAST program, score=50, wordlength=3 to obtain amino acid sequences homologous to AMID01-11 protein molecules of the invention. To obtain gapped alignments for comparison purposes, Gapped BLAST can be utilized as described in Altschul et al., (1997) Nucleic Acids Res. 25(17):3389-3402. When utilizing BLAST and Gapped BLAST programs, the default parameters of the respective programs (e.g., XBLAST and NBLAST) can be used. See http://www.ncbi.nlm.nih.gov.

### Hybridisation

As used herein, the term “hybridizing” is intended to describe conditions for hybridization and washing under which nucleotide sequences at least about 50%, at least about 60%, at least about 70%, more preferably at least about 80%, even more preferably at least about 85% to 90%, more preferably at least 95% homologous to each other typically remain hybridized to each other.

A preferred, non-limiting example of such hybridization conditions are hybridization in 6× sodium chloride/sodium citrate (SSC) at about 45° C., followed by one or more washes in 1×SSC, 0.1% SDS at 50° C., preferably at 55° C., preferably at 60° C. and even more preferably at 65° C.

Highly stringent conditions include, for example, hybridizing at 68° C. in 5×SSC/5×Denhardt's solution/1.0% SDS and washing in 0.2×SSC/0.1% SDS at room temperature. Alternatively, washing may be performed at 42° C.

The skilled artisan will know which conditions to apply for stringent and highly stringent hybridisation conditions. Additional guidance regarding such conditions is readily available in the art, for example, in Sambrook et al., 1989, Molecular Cloning, A Laboratory Manual, Cold Spring Harbor Press, N.Y.; and Ausubel et al. (eds.), 1995, Current Protocols in Molecular Biology, (John Wiley & Sons, N.Y.).

Of course, a polynucleotide which hybridizes only to a poly A sequence (such as the 3′ terminal poly(A) tract of mRNAs), or to a complementary stretch of T (or U) resides, would not be included in a polynucleotide of the invention used to specifically hybridize to a portion of a nucleic acid of the invention, since such a polynucleotide would hybridize to any nucleic acid molecule containing a poly(A) stretch or the complement thereof (e.g., practically any double-standed cDNA clone).

### Obtaining Full Length DNA from Other Organisms

In a typical approach, cDNA libraries constructed from other organisms, e.g. filamentous fungi, in particular from the species Aspergillus can be screened.

For example, Aspergillus strains can be screened for homologous AMID01-11 polynucleotides by Northern blot analysis. Upon detection of transcripts homologous to polynucleotides according to the invention, cDNA libraries can be constructed from RNA isolated from the appropriate strain, utilizing standard techniques well known to those of skill in the art. Alternatively, a total genomic DNA library can be screened using a probe hybridisable to an AMID01-11 polynucleotide according to the invention.

Homologous gene sequences can be isolated, for example, by performing PCR using two degenerate oligonucleotide primer pools designed on the basis of nucleotide sequences as taught herein.

The template for the reaction can be cDNA obtained by reverse transcription of mRNA prepared from strains known or suspected to express a polynucleotide according to the invention. The PCR product can be subcloned and sequenced to ensure that the amplified sequences represent the sequences of a new AMID01-11 nucleic acid sequence, or a functional equivalent thereof.

The PCR fragment can then be used to isolate a full length cDNA clone by a variety of known methods. For example, the amplified fragment can be labeled and used to screen a bacteriophage or cosmid cDNA library. Alternatively, the labeled fragment can be used to screen a genomic library.

PCR technology also can be used to isolate full length cDNA sequences from other organisms. For example, RNA can be isolated, following standard procedures, from an appropriate cellular or tissue source. A reverse transcription reaction can be performed on the RNA using an oligonucleotide primer specific for the most 5′ end of the amplified fragment for the priming of first strand synthesis.

The resulting RNA/DNA hybrid can then be “tailed” (e.g., with guanines) using a standard terminal transferase reaction, the hybrid can be digested with RNase H, and second strand synthesis can then be primed (e.g., with a poly-C primer). Thus, cDNA sequences upstream of the amplified fragment can easily be isolated. For a review of useful cloning strategies, see e.g., Sambrook et al., supra; and Ausubel et al., supra.

Whether or not a homologous DNA fragment encodes a functional AMID01-11 protein, may easily be tested by methods known in the art.

### Vectors

Another aspect of the invention pertains to vectors, preferably expression vectors, containing a polynucleotide sequence as described above, encoding an AMID01-11 protein or a functional equivalent thereof. As used herein, the term “vector” refers to a nucleic acid molecule capable of transporting another nucleic acid to which it has been linked. One type of vector is a “plasmid”, which refers to a circular double stranded DNA loop into which additional DNA segments can be ligated. Another type of vector is a viral vector, wherein additional DNA segments can be ligated into the viral genome. Certain vectors are capable of autonomous replication in a host cell into which they are introduced (e.g., bacterial vectors having a bacterial origin of replication and episomal mammalian vectors). Other vectors (e.g., non-episomal mammalian vectors) are integrated into the genome of a host cell upon introduction into the host cell, and thereby are replicated along with the host genome. Moreover, certain vectors are capable of directing the expression of genes to which they are operatively linked. Such vectors are referred to herein as “expression vectors”. In general, expression vectors of utility in recombinant DNA techniques are often in the form of plasmids. The terms “plasmid” and “vector” can be used interchangeably herein as the plasmid is the most commonly used form of vector. However, the invention is intended to include such other forms of expression vectors, such as viral vectors (e.g., replication defective retroviruses, adenoviruses and adeno-associated viruses), which serve equivalent functions.

The recombinant expression vectors of the invention can comprise a nucleic acid according to invention in a form suitable for expression of the nucleic acid in a host cell. The recombinant expression vector can for example include one or more regulatory sequences, selected on the basis of the host cells to be used for expression, which is operatively linked to the nucleic acid sequence to be expressed. The vector according to the invention preferably comprises the polynucleotide sequence according to the invention operatively linked with regulatory sequences suitable for expression of said polynucleotide sequence in a suitable host cell. Within a recombinant expression vector, “operatively linked” is intended to mean that the nucleotide sequence of interest is linked to the regulatory sequence(s) in a manner which allows for expression of the nucleotide sequence (e.g., in an in vitro transcription/translation system or in a host cell when the vector is introduced into the host cell). The term “regulatory sequence” is intended to include promoters, enhancers and other expression control elements (e.g., polyadenylation signal). Such regulatory sequences are described, for example, in Goeddel; Gene Expression Technology: Methods in Enzymology 185, Academic Press, San Diego, Calif. (1990). Regulatory sequences include those which direct constitutive expression of a nucleotide sequence in many types of host cells and those which direct expression of the nucleotide sequence only in a certain host cell (e.g. tissue-specific regulatory sequences). It will be appreciated by those skilled in the art that the design of the expression vector can depend on such factors as the choice of the host cell to be transformed, the level of expression of protein desired, etc. The expression vectors of the invention can be introduced into host cells to thereby produce proteins or peptides, encoded by nucleic acids as described herein (e.g. AMID01-11 proteins, mutant forms of AMID01-11 proteins, fragments, variants or functional equivalents thereof, etc.).

The recombinant expression vectors of the invention can be designed for expression of AMID01-11 proteins in prokaryotic or eukaryotic cells. For example, AMID01-11 proteins can be expressed in bacterial cells such as E. coli, insect cells (using baculovirus expression vectors) yeast cells, fungal cells or mammalian cells. Suitable host cells are discussed further in Goeddel, Gene Expression Technology: Methods in Enzymology 185, Academic Press, San Diego, Calif. (1990). Alternatively, the recombinant expression vector can be transcribed and translated in vitro, for example using T7 promoter regulatory sequences and T7 polymerase.

Expression vectors useful in the present invention include chromosomal-, episomal- and virus-derived vectors e.g., vectors derived from bacterial plasmids, bacteriophage, filamentous fungi, yeast episome, yeast chromosomal elements, viruses such as baculoviruses, papova viruses, vaccinia viruses, adenoviruses, fowl pox viruses, pseudorabies viruses and retroviruses, and vectors derived from combinations thereof, such as those derived from plasmid and bacteriophage genetic elements, such as cosmids and phagemids.

The DNA insert should be operatively linked to an appropriate promoter, such as the phage lambda PL promoter, the E. coli lac, trp and tac promoters, the SV40 early and late promoters and promoters of retroviral LTRs, to name a few. Other suitable promoters will be known to the skilled person. In a specific embodiment, promoters are preferred that are capable of directing a high expression level of asparaginases in filamentous fungi. Such promoters are known in the art. The expression constructs may contain sites for transcription initiation, termination, and, in the transcribed region, a ribosome binding site for translation. The coding portion of the mature transcripts expressed by the constructs will include a translation initiating AUG at the beginning and a termination codon appropriately positioned at the end of the polypeptide to be translated.

Vector DNA can be introduced into prokaryotic or eukaryotic cells via conventional transformation or transfection techniques. As used herein, the terms “transformation” and “transfection” are intended to refer to a variety of art-recognized techniques for introducing foreign nucleic acid (e.g., DNA) into a host cell, including calcium phosphate or calcium chloride co-percipitation, DEAE-dextran-mediated transfection, transduction, infection, lipofection, cationic lipidmediated transfection or electroporation. Suitable methods for transforming or transfecting host cells can be found in Sambrook, et al. (Molecular Cloning: A Laboratory Manual, 2nd, ed. Cold Spring Harbor Laboratory, Cold Spring Harbor Laboratory Press, Cold Spring Harbor, N.Y., 1989), Davis et al., Basic Methods in Molecular Biology (1986) and other laboratory manuals.

For stable transfection of mammalian cells, it is known that, depending upon the expression vector and transfection technique used, only a small fraction of cells may integrate the foreign DNA into their genome. In order to identify and select these integrants, a gene that encodes a selectable marker (e.g., resistance to antibiotics) is generally introduced into the host cells along with the gene of interest. Preferred selectable markers include those which confer resistance to drugs, such as G418, hygromycin and methatrexate. Nucleic acid encoding a selectable marker can be introduced into a host cell on the same vector as that encoding an AMID01-11 protein or can be introduced on a separate vector. Cells stably transfected with the introduced nucleic acid can be identified by drug selection (e.g. cells that have incorporated the selectable marker gene will survive, while the other cells die).

Expression of proteins in prokaryotes is often carried out in E. coli with vectors containing constitutive or inducible promoters directing the expression of proteins.

As indicated, the expression vectors will preferably contain selectable markers. Such markers include dihydrofolate reductase or neomycin resistance for eukarotic cell culture and tetracyline or ampicilling resistance for culturing in E. coli and other bacteria. Representative examples of appropriate host include bacterial cells, such as E. coli, Streptomyces and Salmonella typhimurium; fungal cells, such as yeast; insect cells such as Drosophila S2 and Spodoptera Sf9; animal cells such as CHO, COS and Bowes melanoma; and plant cells. Appropriate culture media and conditions for the above-described host cells are known in the art.

Among vectors preferred for use in bacteria are pQE70, pQE60 and PQE-9, available from Qiagen; pBS vectors, Phagescript vectors, Bluescript vectors, pNH8A, pNH16A, pNH18A, pNH46A, available from Stratagene; and ptrc99a, pKK223-3, pKK233-3, pDR540, pRIT5 available from Pharmacia. Among preferred eukaryotic vectors are PWLNEO, pSV2CAT, pOG44, pZT1 and pSG available from Sratagene; and pSVK3, pBPV, pMSG and pSVL available from Pharmacia. Other suitable vectors will be readily apparent to the skilled artisan.

Among known bacterial promotors for use in the present invention include E. coli lacI and lacZ promoters, the T3 and T7 promoters, the gpt promoter, the lambda PR, PL promoters and the trp promoter, the HSV thymidine kinase promoter, the early and late SV40 promoters, the promoters of retroviral LTRs, such as those of the Rous sarcoma virus (“RSV”), and metallothionein promoters, such as the mouse metallothionein-I promoter.

Transcription of the DNA encoding the polypeptides of the present invention by higher eukaryotes may be increased by inserting an enhancer sequence into the vector. Enhancers are cis-acting elements of DNA, usually about from 10 to 300 bp that act to increase transcriptional activity of a promoter in a given host cell-type. Examples of enhancers include the SV40 enhancer, which is located on the late side of the replication origin at bp 100 to 270, the cytomegalovirus early promoter enhancer, the polyoma enhancer on the late side of the replication origin, and adenovirus enhancers.

For secretion of the translated protein into the lumen of the endoplasmic reticulum, into the periplasmic space or into the extracellular environment, appropriate secretation signal may be incorporated into the expressed polypeptide. The signals may be endogenous to the polypeptide or they may be heterologous signals.

The polypeptide may be expressed in a modified form and may include not only secretion signals but also additional heterologous functional regions. Thus, for instance, a region of additional amino acids, particularly charged amino acids, may be added to the N-terminus of the polypeptide to improve stability and persistence in the host cell, during purification or during subsequent handling and storage. Also, peptide moieties may be added to the polypeptide to facilitate purification.

### Polypeptides According to the Invention

The invention provides an isolated polypeptide having the amino acid sequence chosen from the group consisting of amino acid sequences according to SEQ ID NO: 23-33, an amino acid sequence obtainable by expressing respectively the polynucleotide of SEQ ID NO: 1-11, in an appropriate host or obtainable by expressing respectively the polynucleotide of SEQ ID NO: 12-22 in an appropriate host. Also, a peptide or polypeptide comprising a functional equivalent of the above polypeptides is comprised within the present invention. The above polypeptides are collectively comprised in the term “polypeptides according to the invention” The terms “peptide” and “oligopeptide” are considered synonymous (as is commonly recognized) and each term can be used interchangeably as the context requires to indicate a chain of at least two amino acids coupled by peptidyl linkages. The word “polypeptide” is used herein for chains containing more than seven amino acid residues. All oligopeptide and polypeptide formulas or sequences herein are written from left to right and in the direction from amino terminus to carboxy terminus. The one-letter code of amino acids used herein is commonly known in the art and can be found in Sambrook, et al. (Molecular Cloning: A Laboratory Manual, 2nd, ed. Cold Spring Harbor Laboratory, Cold Spring Harbor Laboratory Press, Cold Spring Harbor, N.Y., 1989)

By “isolated” polypeptide or protein is intended a polypeptide or protein removed from its native environment. For example, recombinantly produced polypeptides and proteins expressed in host cells are considered isolated for the purpose of the invention as are native or recombinant polypeptides which have been substantially purified by any suitable technique such as, for example, the single-step purification method disclosed in Smith and Johnson, Gene 67:31-40 (1988).

The AMID01-11 amidase according to the invention can be recovered and purified from recombinant cell cultures by well-known methods including ammonium sulfate or ethanol precipitation, acid extraction, anion or cation exchange chromatography, phosphocellulose chromatography, hydrophobic interaction chromatography, affinity chromatography, hydroxylapatite chromatography and lectin chromatography. Most preferably, high performance liquid chromatography (“HPLC”) is employed for purification.

Polypeptides of the present invention include naturally purified products, products of chemical synthetic procedures, and products produced by recombinant techniques from a prokaryotic or eukaryotic host, including, for example, bacterial, yeast, higher plant, insect and mammalian cells. Depending upon the host employed in a recombinant production procedure, the polypeptides of the present invention may be glycosylated or may be non-glycosylated. In addition, polypeptides of the invention may also include an initial modified methionine residue, in some cases as a result of host-mediated processes.

### Protein Fragments

The invention also features biologically active fragments of the polypeptides according to the invention.

Biologically active fragments of a polypeptide of the invention include polypeptides comprising amino acid sequences sufficiently identical to or derived from the amino acid sequence of the AMID01-11 protein (e.g., the amino acid sequence respectively chosen from the group consisting of SEQ ID NO: 23-33), which include fewer amino acids than the full length protein, and exhibit at least one biological activity of the corresponding full-length protein. Typically, biologically active fragments comprise a domain or motif with at least one activity of the AMID01-11 protein.

A biologically active fragment of a protein of the invention can be a polypeptide which is, for example, 10, 25, 50, 100 or more amino acids in length. Moreover, other biologically active portions, in which other regions of the protein are deleted, can be prepared by recombinant techniques and evaluated for one or more of the biological activities of the native form of a polypeptide of the invention.

The invention also features nucleic acid fragments which encode the above biologically active fragments of the AMID01-11 protein.

### Functional Equivalents

The terms “functional equivalents” and “functional variants” are used interchangeably herein. Functional equivalents of AMID01-11 DNA are isolated DNA fragments that encode a polypeptide that exhibits a particular function of the AMID01-11 A. niger amidase as defined herein. A functional equivalent of an AMID01-11 polypeptide according to the invention is a polypeptide that exhibits at least one function of an A. niger amidase as defined herein. Functional equivalents therefore also encompass biologically active fragments.

Functional protein or polypeptide equivalents may contain only conservative substitutions of one or more amino acids chosen from the group consisting of SEQ ID NO: 23-33 or substitutions, insertions or deletions of non-essential amino acids. Accordingly, a non-essential amino acid is a residue that can be altered in an amino acid chosen from the group consisting of SEQ ID NO: 23-33 without substantially altering the biological function. For example, amino acid residues that are conserved among the AMID01-11 proteins of the present invention, are predicted to be particularly unamenable to alteration. Furthermore, amino acids conserved among the AMID01-11 proteins according to the present invention and other amidases are not likely to be amenable to alteration.

The term “conservative substitution” is intended to mean that a substitution in which the amino acid residue is replaced with an amino acid residue having a similar side chain. These families are known in the art and include amino acids with basic side chains (e.g. lysine, arginine and hystidine), acidic side chains (e.g. aspartic acid, glutamic acid), uncharged polar side chains (e.g., glycine, asparagines, glutamine, serine, threonine, tyrosine, cysteine), non-polar side chains (e.g., alanine, valine, leucine, isoleucine, proline, phenylalanine, methionine, tryptophan), beta-branched side chains (e.g., threonine, valine, isoleucine) and aromatic side chains (e.g., tyrosine, phenylalanine tryptophan, histidine).

Functional nucleic acid equivalents may typically contain silent mutations or mutations that do not alter the biological function of encoded polypeptide. Accordingly, the invention provides nucleic acid molecules encoding AMID01-11 proteins that contain changes in amino acid residues that are not essential for a particular biological activity. Such AMID01-11 proteins differ in amino acid sequence chosen from the group consisting of SEQ ID NO: 23-33 yet retain at least one biological activity. In one embodiment the isolated nucleic acid molecule comprises a nucleotide sequence encoding a protein, wherein the protein comprises a substantially homologous amino acid sequence of at least about 40%, 65%, 70%, 75%, 80%, 85%, 90%, 95%, 96%, 97%, 98%, 99% or more homologous to the amino acid sequence shown any amino acid sequence chosen from the group consisting of SEQ ID NO: 23-33.

For example, guidance concerning how to make phenotypically silent amino acid substitutions is provided in Bowie, J. U. et al., Science 247:1306-1310 (1990) wherein the authors indicate that there are two main approaches for studying the tolerance of an amino acid sequence to change. The first method relies on the process of evolution, in which mutations are either accepted or rejected by natural selection. The second approach uses genetic engineering to introduce amino acid changes at specific positions of a cloned gene and selects or screens to identify sequences that maintain functionality. As the authors state, these studies have revealed that proteins are surprisingly tolerant of amino acid substitutions. The authors further indicate which changes are likely to be permissive at a certain position of the protein. For example, most buried amino acid residues require non-polar side chains, whereas few features of surface side chains are generally conserved. Other such phenotypically silent substitutions are described in Bowie et al, supra, and the references cited therein.

An isolated nucleic acid molecule encoding an AMID01-11 protein homologous to the protein according to any protein chosen from the group consisting of SEQ ID NO: 23-33 can be created by introducing one or more nucleotide substitutions, additions or deletions into the coding nucleotide sequences chosen from the group consisting of SEQ ID NO: 1-11 or chosen from the group consisting of SEQ ID NO: 12-22 such that one or more amino acid substitutions, deletions or insertions are introduced into the encoded protein. Such mutations may be introduced by standard techniques, such as site-directed mutagenesis and PCR-mediated mutagenesis.

The term “functional equivalents” also encompasses orthologues of the A. niger AMID01-11 protein. Orthologues of the A. niger AMID01-11 protein are proteins that can be isolated from other strains or species and possess a similar or identical biological activity. Such orthologues can readily be identified as comprising an amino acid sequence that is substantially homologous to an amino acid sequence chosen from the group consisting of SEQ ID NO: 23-33.

As defined herein, the term “substantially homologous” refers to a first amino acid or nucleotide sequence which contains a sufficient or minimum number of identical or equivalent (e.g., with similar side chain) amino acids or nucleotides to a second amino acid or nucleotide sequence such that the first and the second amino acid or nucleotide sequences have a common domain. For example, amino acid or nucleotide sequences which contain a common domain having about 40%, preferably 65%, more preferably 70%, even more preferably 75%, 80%, 85%, 90%, 95%, 96%, 97%, 98% or 99% identity or more are defined herein as sufficiently identical.

Also, nucleic acids encoding other AMID01-11 family members, which thus have a nucleotide sequence that differs from the group consisting of SEQ ID NO: 1-11 or from the group consisting of SEQ ID NO: 12-22, are within the scope of the invention. Moreover, nucleic acids encoding AMID01-11 proteins from different species which thus have a nucleotide sequence which differs from the group consisting of SEQ ID NO: 1-11 or from the group consisting of SEQ ID NO: 12-22 are within the scope of the invention.

Nucleic acid molecules corresponding to variants (e.g. natural allelic variants) and homologues of the AMID01-11 DNA of the invention can be isolated based on their homology to the AMID01-11 nucleic acids disclosed herein using the cDNAs disclosed herein or a suitable fragment thereof, as a hybridisation probe according to standard hybridisation techniques preferably under highly stringent hybridisation conditions.

In addition to naturally occurring allelic variants of the AMID01-11 sequence, the skilled person will recognise that changes can be introduced by mutation into the nucleotide sequences chosen from the group consisting of SEQ ID NO: 1-11 or from the group consisting of SEQ ID NO: 12-22 thereby leading to changes in the amino acid sequence of the AMID01-11 protein without substantially altering the function of the AMID01-11 protein.

In another aspect of the invention, improved AMID01-11 proteins are provided. Improved AMID01-11 proteins are proteins wherein at least one biological activity is improved. Such proteins may be obtained by randomly introducing mutations along all or part of the AMID01-11 coding sequence, such as by saturation mutagenesis, and the resulting mutants can be expressed recombinantly and screened for biological activity. For instance, the art provides for standard assays for measuring the enzymatic activity of amidases and thus improved proteins may easily be selected.

In a preferred embodiment the AMID01-11 protein has an amino acid sequence according to SEQ ID NO: 3. In another embodiment, the AMID01-11 polypeptide is substantially homologous to the amino acid sequence chosen from the group consisting of SEQ ID NO: 23-33 and retains at least one biological activity of a polypeptide chosen from the group consisting of SEQ ID NO: 23-33, yet differs in amino acid sequence due to natural variation or mutagenesis as described above.

In a further preferred embodiment, the AMID01-11 protein has an amino acid sequence encoded by an isolated nucleic acid fragment capable of hybridising to a nucleic acid chosen respectively from the group consisting of SEQ ID NO: 1-11 or from the group consisting of SEQ ID NO: 12-22, preferably under highly stringent hybridisation conditions.

Accordingly, the AMID01-11 protein is a protein which comprises an amino acid sequence at least about 40%, 65%, 70%, 75%, 80%, 85%, 90%, 95%, 96%, 97%, 98%, 99% or more homologous to the amino acid sequence as respectively chosen from the group consisting of SEQ ID NO: 23-33 and retains at least one functional activity of the polypeptide as chosen from the group consisting of SEQ ID NO: 23-33.

Functional equivalents of a protein according to the invention can also be identified e.g. by screening combinatorial libraries of mutants, e.g. truncation mutants, of the protein of the invention for asparaginase activity. In one embodiment, a variegated library of variants is generated by combinatorial mutagenesis at the nucleic acid level. A variegated library of variants can be produced by, for example, enzymatically ligating a mixture of synthetic oligonucleotides into gene sequences such that a degenerate set of potential protein sequences is expressible as individual polypeptides. There are a variety of methods that can be used to produce libraries of potential variants of the polypeptides of the invention from a degenerate oligonucleotide sequence. Methods for synthesizing degenerate oligonucleotides are known in the art (see, e.g., Narang (1983) Tetrahedron 39:3; Itakura et al. (1984) Annu. Rev. Biochem. 53:323; Itakura et al. (1984) Science 198:1056; Ike et al. (1983) Nucleic Acid Res. 11:477).

In addition, libraries of fragments of the coding sequence of a polypeptide of the invention can be used to generate a variegated population of polypeptides for screening a subsequent selection of variants. For example, a library of coding sequence fragments can be generated by treating a double stranded PCR fragment of the coding sequence of interest with a nuclease under conditions wherein nicking occurs only about once per molecule, denaturing the double stranded DNA, renaturing the DNA to form double stranded DNA which can include sense/antisense pairs from different nicked products, removing single stranded portions from reformed duplexes by treatment with S1 nuclease, and ligating the resulting fragment library into an expression vector. By this method, an expression library can be derived which encodes N-terminal and internal fragments of various sizes of the protein of interest.

Several techniques are known in the art for screening gene products of combinatorial libraries made by point mutations of truncation, and for screening cDNA libraries for gene products having a selected property. The most widely used techniques, which are amenable to high through-put analysis, for screening large gene libraries typically include cloning the gene library into replicable expression vectors, transforming appropriate cells with the resulting library of vectors, and expressing the combinatorial genes under conditions in which detection of a desired activity facilitates isolation of the vector encoding the gene whose product was detected. Recursive ensemble mutagenesis (REM), a technique which enhances the frequency of functional mutants in the libraries, can be used in combination with the screening assays to identify variants of a protein of the invention (Arkin and Yourvan (1992) Proc. Natl. Acad. Sci. USA 89:7811-7815; Delgrave et al. (1993) Protein Engineering 6(3):327-331).

In addition to the AMID01-11 gene sequence respectively shown in SEQ ID NO: 1-11, it will be apparent for the person skilled in the art that DNA sequence polymorphisms that may lead to changes in the amino acid sequence of the AMID01-11 protein may exist within a given population. Such genetic polymorphisms may exist in cells from different populations or within a population due to natural allelic variation. Allelic variants may also include functional equivalents.

Fragments of a polynucleotide according to the invention may also comprise polynucleotides not encoding functional polypeptides. Such polynucleotides may function as probes or primers for a PCR reaction.

Nucleic acids according to the invention irrespective of whether they encode functional or non-functional polypeptides, can be used as hybridization probes or polymerase chain reaction (PCR) primers. Uses of the nucleic acid molecules of the present invention that do not encode a polypeptide having an AMID01-11 activity include, inter alia, (1) isolating the gene encoding the AMID01-11 protein, or allelic variants thereof from a cDNA library e.g. from other organisms than A. niger, (2) in situ hybridization (e.g. FISH) to metaphase chromosomal spreads to provide precise chromosomal location of the AMID01-11 gene as described in Verma et al., Human Chromosomes: a Manual of Basic Techniques, Pergamon Press, New York (1988); (3) Northern blot analysis for detecting expression of AMID01-11 mRNA in specific tissues and/or cells and 4) probes and primers that can be used as a diagnostic tool to analyse the presence of a nucleic acid hybridisable to the AMID01-11 probe in a given biological (e.g. tissue) sample.

Also encompassed by the invention is a method of obtaining a functional equivalent of an AMID01-11 gene or cDNA. Such a method entails obtaining a labelled probe that includes an isolated nucleic acid which encodes all or a portion of the sequence chosen from the group consisting of SEQ ID NO: 23-33 or a variant thereof; screening a nucleic acid fragment library with the labelled probe under conditions that allow hybridisation of the probe to nucleic acid fragments in the library, thereby forming nucleic acid duplexes, and preparing a full-length gene sequence from the nucleic acid fragments in any labelled duplex to obtain a gene related to the AMID01-11 gene.

In one embodiment, an AMID01-11 nucleic acid of the invention is at least 40%, 65%, 70%, 75%, 80%, 85%, 90%, 91%, 92%, 93%, 94%, 95%, 96%, 97%, 98%, 99%, or more homologous to a nucleic acid sequence chosen from the group consisting of SEQ ID NO: 1-11 or from the group consisting of SEQ ID NO: 12-22 or the complement of any of them.

In another preferred embodiment an AMID01-11 polypeptide of the invention is at least 40%, 65%, 70%, 75%, 80%, 85%, 90%, 91%, 92%, 93%, 94%, 95%, 96%, 97%, 98%, 99%, or more homologous to the amino acid sequence shown in a peptide sequence chosen from the group consisting of SEQ ID NO: 23-33.

### Host Cells

In another embodiment, the invention features cells, e.g., transformed host cells or recombinant host cells that contain a nucleic acid encompassed by the invention. A “transformed cell” or “recombinant cell” is a cell into which (or into an ancestor of which) has been introduced, by means of recombinant DNA techniques, a nucleic acid according to the invention. Both prokaryotic and eukaryotic cells are included, e.g., bacteria, fungi, yeast, and the like, especially preferred are cells from filamentous fungi, in particular Aspergillus niger.

A host cell can be chosen that modulates the expression of the inserted sequences, or modifies and processes the gene product in a specific, desired fashion. Such modifications (e.g., glycosylation) and processing (e.g., cleavage) of protein products may facilitate optimal functioning of the protein.

Various host cells have characteristic and specific mechanisms for post-translational processing and modification of proteins and gene products. Appropriate cell lines or host systems familiar to those of skill in the art of molecular biology and/or microbiology can be chosen to ensure the desired and correct modification and processing of the foreign protein expressed. To this end, eukaryotic host cells that possess the cellular machinery for proper processing of the primary transcript, glycosylation, and phosphorylation of the gene product can be used. Such host cells are well known in the art.

Host cells also include, but are not limited to, mammalian cell lines such as CHO, VERO, BHK, HeLa, COS, MDCK, 293, 3T3, W138, and choroid plexus cell lines.

If desired, the polypeptides according to the invention can be produced by a stably-transfected cell line. A number of vectors suitable for stable transfection of mammalian cells are available to the public, methods for constructing such cell lines are also publicly known, e.g., in Ausubel et al. (supra).

In another aspect, the invention provides food products obtainable by the process of the invention as described hereinbefore or by the use of the novel asparaginase as described hereinbefore to produce food products. These food products are characterized by significantly reduced acrylamide levels in comparison with the food products obtainable by production processes that do not comprise adding one or more enzymes in an amount that is effective in reducing the level of amino acids which are involved in the formation of acrylamide during said heating step. The process according to the invention can be used to obtain a decrease of the acrylamide content of the produced food product preferably more than 50%, more preferably more than 70%, even more preferably 80% and most preferably more than 90% compared to a food product obtained with the conventional process.

### EXAMPLE 1

### Cloning of Amidase Enzymes

Two types of constructs were used. The first type contains the “standard” amdS selection marker, which allows a direct selection of transformed strains on the selective substrate acetamide. This is quite suitable for secreted amidases, but for intracellular enzymes it has the drawback that there will be a background activity of the marker acetamidase. Therefore, for a number of amidases that were predicted to be intracellular, a second type of construct was used, employing a marker-less construct, introduced by co-transformation with a second vector harbouring the phleomycin resistance marker.

Gene Isolation

1. Empty cassette as background/negative control

2. A. niger amdS acetamidase (SEQ ID NO: 11)

3. E. nidulans amdS acetamidase

4. New amidases: see Table 1.

TABLE 1
Novel amidases according to the invention from Aspergillus niger

| Enzyme | Enzyme | | | |
|---|---|---|---|---|
| Code in | Code in | SEQ ID | SEQ ID | SEQ ID |
| description | Examples | DNA | cDNA | Protein |
| AMID01 | ZDK | 1 | 12 | 23 |
| AMID02 | AAG | 2 | 13 | 24 |
| AMID03 | AAA | 3 | 14 | 25 |
| AMID04 | ZDN | 4 | 15 | 26 |
| AMID05 | AAE | 5 | 16 | 27 |
| AMID06 | ZDM | 6 | 17 | 28 |
| AMID07 | ZDL | 7 | 18 | 29 |
| AMID08 | ZDJ | 8 | 19 | 30 |
| AMID09 | AAC | 9 | 20 | 31 |
| AMID10 | ZDO | 10 | 21 | 32 |
| AMID11 | AmdS | 11 | 22 | 33 |

The DNA and predicted amino acid sequences of these genes are given in the sequence listing at the end of this document and are referred to as given indicated above.

Oligonucleotide primers were designed to amplify the gene encoding the gene of interest from the genome of A. niger CBS513.88. As said before the primers suitable to pick up the genes according to the invention can be made as known to the person skilled in the art. Table 2 shows the nucleotide sequence of the oligonucleotide primers that were used for amplification of some of the amidase genes according to the invention.

TABLE 2

Primer sequences

| | | |
|---|---|---|
| Gene | Upstream primer | Downstream primer |

| | | |
|---|---|---|
| ZDJ | 5′CCCTTAATTAACTCATAGGCATCATG | 5′TTAGGCGCGCCAATTAGAGTGACCACAA |
| | GACGAGAAGCCTCAGTTCTT3′ | ATCCC3′ |
| | (SEQ ID NO: 34) | (SEQ ID NO: 35) |
| ZDL | 5′CCCTTAATTAACTCATAGGCATCATG | 5′TTAGGCGCGCCGAGACCGACTAGCCCG |
| | GCTCGTATCGATTTGTCC3′ | TGAA3′ |
| | (SEQ ID NO: 36) | (SEQ ID NO: 37) |
| ZDM | 5′CCCTTAATTAACTCATAGGCATCATG | 5′TTAGGCGCGCCGCATGCCGTCCAAGTTA |
| | TCGGTATTGTTCACTTCTAT3′ | CCC3′ |
| | (SEQ ID NO: 38) | (SEQ ID NO: 39) |
| ZDO | 5′CCCTTAATTAACTCATAGGCATCATG | 5′TTAGGCGCGCCCGTCAAATACCAATCGT |
| | GTGCGCGCTACCCAACT3′ | ATGTG3′ |
| | (SEQ ID NO: 40) | (SEQ ID NO: 41) |

The structure of these oligonucleotide primers was similar for all genes that were amplified.

At the 5′-end of the upstream primer, a PacI restriction site is located for facilitation of the cloning procedure. In the middle, a linker to the start codon was added. The 3′-end of the upstream primer is complementary to the 5′-end of the gene of interest, including the ATG start codon. The structure of all upstream primers was: 5′-CCCTTAATTAACTCATAGGCATCATG-gene specific sequence-3′, where the ATG start codon is underlined.

At the 5′-end of the downstream primer, an AscI restriction site is located for facilitation of the cloning procedure. The 3′-end of the upstream primer is complementary to the reverse of the 3′-end of the gene of interest, approximately 100 base pairs downstream of the stop codon. The structure of all downstream primers was: 5′-TTAGGCGCGCC-gene specific sequence-3′.

The length of the gene specific sequence in the primers was 20-25 nucleotides, depending on the GC content of the complementary part of the primer.

Genomic DNA was isolated from A. niger CBS513.88 according to standard procedure, and used in a PCR reaction with both the upstream and downstream primers to amplify the gene encoding the amidase of interest. A person skilled in the art will know how to optimize PCR conditions for each gene and primer combination.

The PCR fragments were cloned in the pCR2.1 (Invitrogen) vector and amplified in E. coli. After digestion of the plasmid with PacI and AscI, the amidase genes were subcloned in an Aspergillus expression vector.

For the genes ZDK and ZDN, the procedure was different. These genes were isolated from an Aspergillus niger cDNA library, constructed according to the methods described in “Molecular Cloning: A Laboratoy Manual, Sambrook et al., New York: Cold Spring Harbour Press, 1989”. After high throughput sequencing of 20.000 clones we identified these genes as amidase homologues and these were selected for expression in A. niger, again by sub-cloning into one of the following expression vectors.

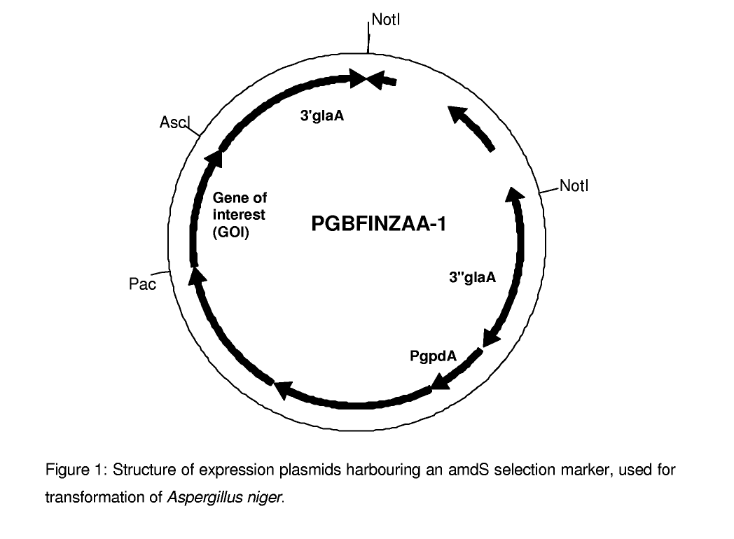

In the cases where the amdS selection marker was used, the expression vector was pGBFIN5 (WO 9932617). The expression vector was also digested with PacI and AscI. Correct orientation of the insert in the resulting plasmids was checked by digestion with suitable restriction enzymes and sequence analysis of the inserted gene. This cloning procedure positions the amidase gene downstream of the Aspergillus niger glaA promoter, and upstream of the glaA terminator. Additionally the Aspergillus nidulans amdS gene is present on this plasmid for convenient selection in A. niger (WO 9846772). The structure of these expression plasmids is depicted in FIG. 1.

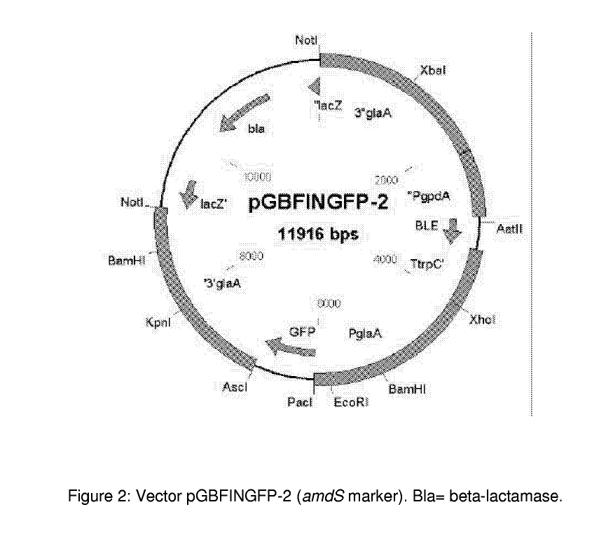

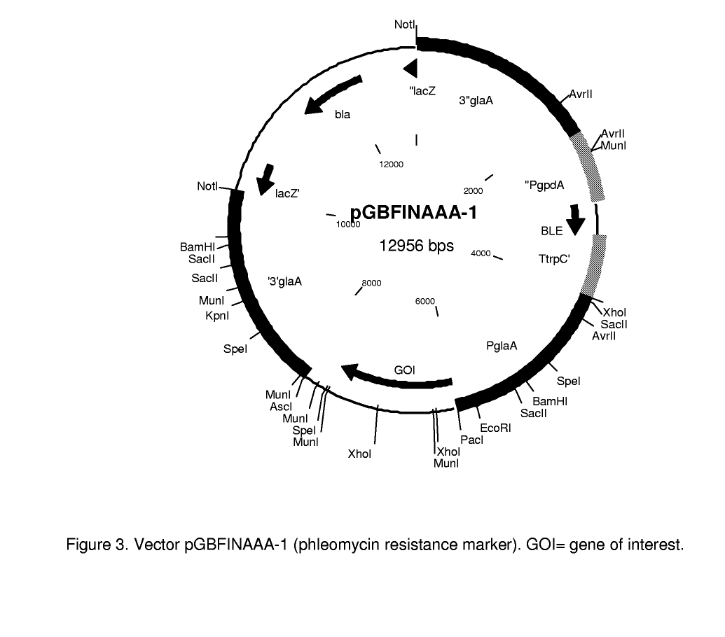

In cases where the phleomycin selection marker was used, the expression vector was pGBFINGFP-2 (FIG. 2). The expression vector was also digested with PacI and AscI. Correct orientation of the insert in the resulting plasmids was checked by digestion with suitable restriction enzymes and sequence analysis of the inserted gene. This cloning procedure replaces the GFP gene in the pGBFINGFP-2 vector with the gene of interest, and positions the amidase gene downstream of the Aspergillus niger glaA promoter, and upstream of the glaA terminator, resulting in pGBFINAAA-1 (FIG. 3). Additionally, a phleomycin resistance gene is present on this plasmid, for convenient selection in A. niger.

Overexpression in Aspergillus niger

A. niger CBS513.88 has been used as host for the over-expression of the aspartic protease gene. Therefore, the expression vectors were transformed to this fungus. The transformation procedure is extensively described in WO 9846772. It is also described how to select for transformants, and targeted multicopy integrants. Preferably, A. niger transformants containing multiple copies of the expression cassette were selected for generation of sample material.

A. niger strains containing multiple copies of the expression cassette were used for generation of sample material by cultivation of the strains in shake flask cultures. A useful method for cultivation of A. niger strains and separation of the mycelium from the culture broth is described in WO 9846772. The culture broth was subsequently used for purification of the amidase and measurement of amidase activity.

### EXAMPLE 2

### Fermentation of Aspergillus niger and Preparation of Culture Extracts

The amidase enzymes were obtained by growing the transformed A. niger strains in the following way.

Fresh spores (106-107) of A. niger strains were inoculated in 20 ml CSL-medium (100 ml flask, baffle) and grown for 20-24 hours at 34° C. and 170 rpm. After inoculation of 5-10 ml CSL pre-culture in 100 ml of the following medium: 150 g/1 maltose, 60 g/l bacto soytone, 1 g/l NaH₂PO₄, 15 g/l (NH₄)₂SO₄, 1 g/l MgSO4.4H2O, 0.08 g/l tween-80, 0.02 g/l Basildon, 20 g/l Morpholino Ethane Sulfonicacid (MES), 1 g/l L-arginine, in 500 ml baffled shake flasks, at 30° C. and 250 rpm for 5 days.

Biomass was collected by centrifugation in 50 ml Greiner tubes (30 minutes, 5000 rpm, 4° C.). All subsequent steps were performed on ice. For the isolation and determination of intracellular enzymes, cell-free extracts were prepared by grinding the biomass in the pellet fraction to powder in liquid nitrogen. For the isolation and determination of secreted enzymes, cell-free supernatants were obtained by a first filtration over a GF/A Whatman Glass microfiber filter (150 mm/-E) to remove the larger particles, followed by adjustment of the pH-value to pH=5 with 4 N KOH (if necessary) and sterile-filtration over a 0.2 μm (bottle-top) filter with suction to remove the fungal material. The supernatant fractions were stored at 4° C. (or −20° C.).

### EXAMPLE 3

### Detection of Amidase Activity by NMR

Cell extract powder (prepared as described above) was freeze-dried and re-solubilised in phosphate-buffered D₂O (pD=7.0), at a concentration of 50 mg/ml. After centrifugation, the supernatant was mixed 1:1 (v/v) with amide substrate (10 mg/ml in D₂O), and incubated at 37° C. After sufficient incubation time (see further Examples), the incubation mixtures were centrifuged (final concentration 5 mg/ml substrate and 25 mg/ml extract). Measurement of the acetamidase activity was performed by Nuclear Magnetic Resonance as described by the manufacturer's instructions. ¹H NMR spectra were recorded on a Bruker DRX-600 operating at a proton frequency of 600 MHz at a probe temperature of 300 K. A 5 mm triple resonance probe with self-shielded gradients was used. 1H NMR spectra of all reference compounds were acquired in order to show that all the compounds involved have unique NMR signals, based on which they can be identified and quantified (not shown). In order to create perfect reference spectra of every relevant compound, a stock solution of each compound was prepared in D₂O (Cambridge Isotope Laboratories). Stock solutions were prepared in concentrations of 10 mg/ml by weighing the substrate or the reference compound and adding D₂O. From these stock solutions, 500 μl was mixed with 500 μl 0.5 M phosphate buffer pH 6.96 (KH₂PO₄/K₂HPO₄). 1H-NMR spectra of each compound, i.e. acrylamide, acrylic acid, acetamide, acetic acid, propionamide and propionic acid were subsequently collected at 600 MHz in D₂O at 27° C. (final concentration 5 mg/ml substrate or reference compound in D₂O). Unique chemical shifts, which did not overlap with signals caused by other compounds, were identified for each compound. In addition, the purity of each reference was checked and the absence of possible contaminants was confirmed.

The compounds had the following characteristic signals:

Acrylamide (catalog number 8.00830, lot 4202056, Merck N.J. USA): 5.82 (dd, Hb, J=10.3 Hz, 1.2 Hz), 6.22 (dd, Hc, J=17.2 Hz, 1.2 Hz), 6.28 (d, Ha, J=10.3 Hz), 6.31 (d, Ha, J=10.3 Hz) ppm.

Acrylic acid (catalog number 14,723-0, lot S17163-034, Aldrich, Wis. USA): 5.65 (dd, Hb, J=10.4 Hz, 1.6 Hz), 6.01 (dd, Hc, J=17.4 Hz, 1.6 Hz), 6.11 (d, CH₂═CH, 3J=10.3 Hz), 6.14 (d, CH₂═CH, 3J=10.3 Hz).

Acetamide (catalog number 12,263-7, lot16813BA-453, Aldrich, Wis. USA): 1.99 (s, CH₃) ppm.

Acetic acid (catalog number 1.00063, lot K31668363, Merck N.J. USA): 1.90 (s, CH₃) ppm.

Propionamide (catalog number 14,393-6, lot 25009JB-413, Aldrich, Wis. USA): 1.10 (t, CH₃), 2.27 (q, CH₂) ppm.

Propionic acid (catalog number P-1386, lot 083 K3404, Sigma, St Louis, Mo. USA): 1.09 (t, CH₃), 2.37 (q, CH₂) ppm.

### EXAMPLE 4

### Detection of Amidase Activity by Calorimetric Determination

The activity determination was essentially performed according to Skouloubris et al. [Mol. Microbiol. 40: 596-609, 2001]. The reaction proceeds in a buffering solution (PEB), containing 100 mM phosphate (pH=7.4) and 10 mM EDTA. A 100 mM solution of the amide substrates was prepared in PEB. 200 ml of this substrate solution was mixed with 50 ml cell extract, and the mixture was incubated for 30 minutes at 30-37° C. The activity of the enzyme was quantified by determining the amount of ammonia that had been released. To this end, 400 ml phenol-nitroprusside and 400 ml alkaline hypochlorite were added, and the mixture was incubated for a further 6 to 10 minutes at 50-55° C. The absorbance was measured at 625 nm, and the amount of ammonia formed was calculated from a calibration curve, using 0-25 ml of 5 mM (NH₄)₂SO₄ adjusted to 50 ml with PEB. One unit of amidase is defined as the amount of enzyme required for hydrolysing 1 μmol of amide/min/mg total protein.

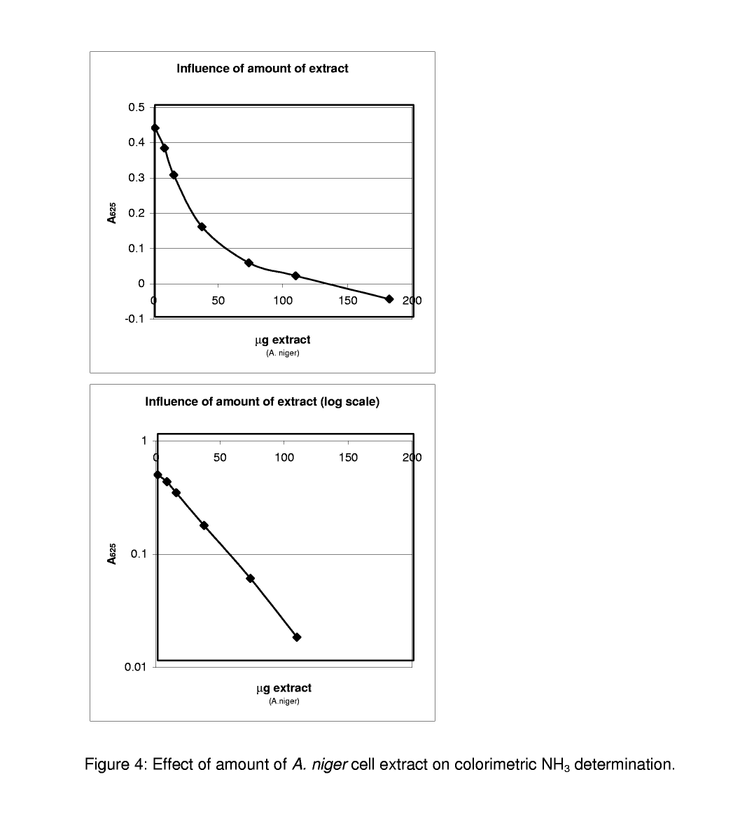

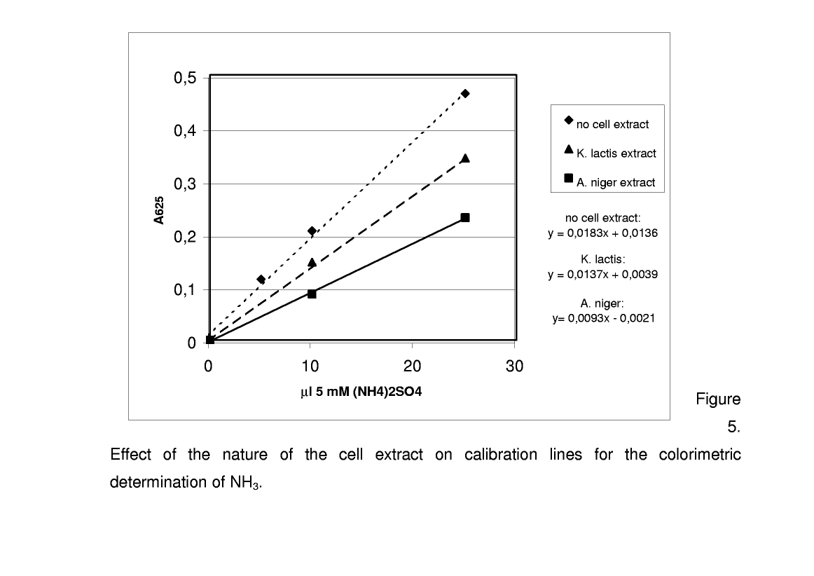

It was found that the calorimetric assay was influenced by the amount of cell extract used in the incubation. If increasing amounts of A. niger cell extract were added to the highest concentration of the calibration curve (25 ml 5 mM (NH₄)₂SO₄), the light absorption decreased from 0.44 all the way to 0 (FIG. 4).

Therefore, the calibration lines must be made in the presence of the appropriate amount of cell extract. Moreover, it was found that the nature of the cell extract was of influence. If calibration lines were made with either 20 ml A. niger extract or 20 ml K. lactis extract, the first line had a significantly lower slope (FIG. 5).

### EXAMPLE 5

### Sigma Amidase

Amidase from Pseudomonas aeruginosa was purchased from Sigma (St. Louis, Mo., USA, enzyme produced in E. Coli, Catalogue Number A6691). To determine the activity of the enzyme towards various amide substrates in highly concentrated form, 10 μl enzyme solution (containing 0.47 mg protein) was mixed with 500 μl phosphate buffer in D₂O (0.5 M, pD=6.96), and subsequently 500 μl amide-substrate solution (10 mg/ml in D₂O) was added. The final concentration of the amide substrates was 5 mg/ml, corresponding to 70 mM for acrylamide, to 85 mM for acetamide, and to 68 mM for propionamide. Additional incubations were performed with 100-fold and 1000-fold dilutions of the enzyme.

After drawing a sample for t=0, the reaction mixture was incubated at room temperature for the incubation with concentrated enzyme, and at 37° C. for the incubations with diluted enzyme. Table 3 shows the percentage conversion of the amide substrates at the indicated time points

The results show that the P. aeruginosa enzyme is capable of hydrolysing all three substrates, but that the activity towards acrylamide is much lower than towards the other two substrates. The results for acrylamide suggest that the initial conversion rate is quite high, but that the conversion stops after a certain period.

TABLE 3
Percentage conversion after incubation
with P. aeruginosa amidase

| | | T | 100-fold | t | 1000-fold | t |
|---|---|---|---|---|---|---|
| substrate | Undiluted | (h) | diluted | (h) | diluted | (h) |
| Acrylamide | 100% | 0.2 | 1.6% | 0.3 | 0.2% | 0.5 |
| | | | 8.8% | 19.8 | 0.5% | 20.0 |
| | | | 8.8% | 43.3 | 0.5% | 43.4 |
| Acetamide | 87% | 0.4 | 1.8% | 0.6 | 0.3% | 0.7 |
| | 100% | 0.5 | 56% | 3.5 | 9.8% | 22.6 |
| | | | 100% | 22.5 | 18% | 45.4 |
| | | | | | 26% | 69.6 |
| | | | | | 46% | 168.0 |
| Propionamide | 78% | 0.1 | 2.5% | 0.3 | 1.2% | 0.5 |
| | 100% | 0.2 | 100% | 20.1 | 20% | 20.2 |
| | | | | | 27.6% | 43.8 |
| | | | | | 30.9% | 68.2 |
| | | | | | 32.3% | 168.0 |

### EXAMPLE 6

### Detection and partial purification of extracellular amidases in Aspergillus niger

The extracellular amidases ZDK and ZDO were partially purified by a sequence of chromatographic steps from culture supernatant, prepared as described previously. The supernatant was first concentrated 5 to 7-fold by ultrafiltration, using a Biomax-10 membrane, and the pH was adjusted to the value of the buffer of the first chromatographic step. After each chromatographic step, the collected fractions (including the unbound flow-through fraction) were analysed for the presence of the desired protein by SDS-PAGE, the fractions containing the desired protein were pooled, again concentrated by ultrafiltration, and their pH adjusted to the pH of the subsequent chromatographic step.

First the columns were equilibrated with 5 column volumes of the specified buffers. Then the sample was loaded on the column, and the column was washed with an additional 3 column volumes of buffer equilibration. Then the samples were eluted from the column by an NaCl gradient, going from the equilibration buffer to the same buffer system with 1 M NaCl added to it, in 20 column volumes.

TABLE 4
Summary of chromatographic steps

| Step | Column | Resin |
|---|---|---|
| 1 | HiTrap DEAE | DEAE-Sepharose |
| 2 | HiTrap SP FF | SP-Sepharose |
| 3 | HiTrap Q FF | Q-Sepharose |
| 4 | XK 16/20 | Hydroxyapatite |

TABLE 5
Summary of chromatographic conditions

| Protein | Step | Buffer | pH |
|---|---|---|---|
| ZDK | 1 | NaPi 50 mM | 6.0 |
| | 2 | NaAc 50 mM | 4.0 |
| | 4 | NaPi 10 mM | 6.8 |
| ZDO | 1 | TRIS-HCl 25 mM | 7.0 |
| | 2 | NaAc 25 mM | 4.0 |
| | 3 | TRIS-HCl 25 mM | 7.0 |
| | 4 | NaPi 10 mM | 6.8 |

Step 3 was omitted for the ZDK purification

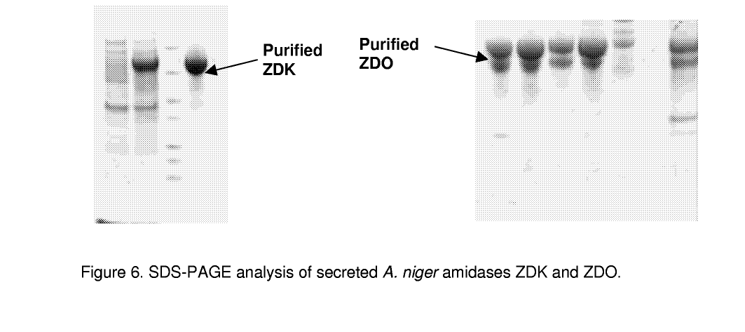

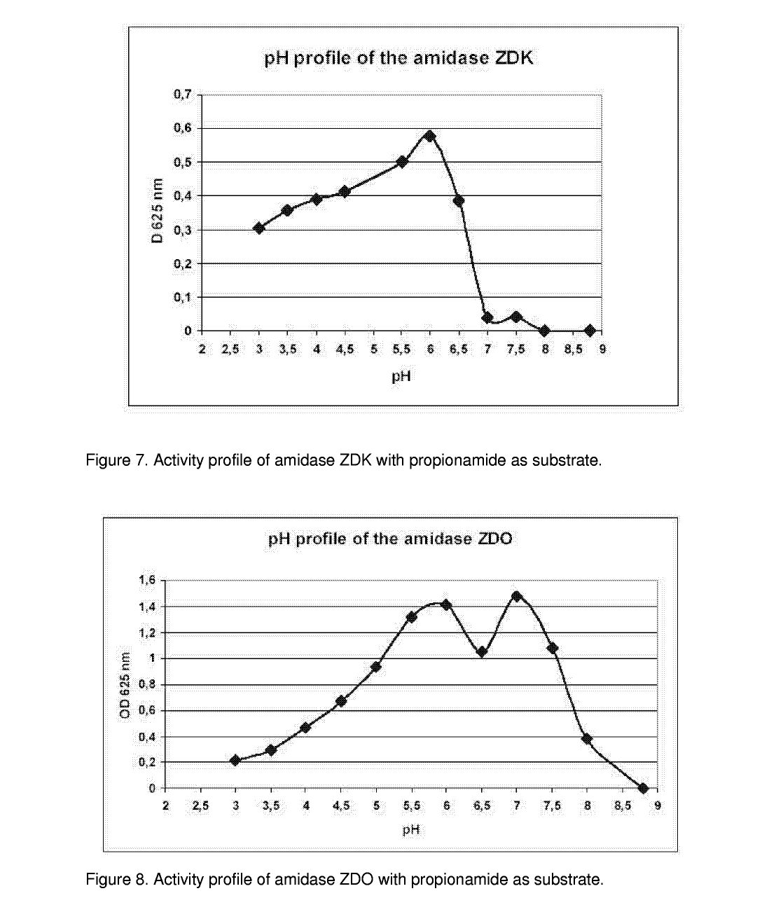

According to SDS-PAGE analysis, the ZDK in the final preparation was about 90% pure, whereas a similar preparation of amidase ZDO showed some additional protein bands (FIG. 6). The concentration of total protein in both samples was about 0.5 mg/ml.

### EXAMPLE 7

### Measurement of the Aspergillus niger intracellular amidases in cell-free extract

Cell-free extracts were prepared as described previously. These extracts were used to determine the activity of the intracellular amidases expressed in A. niger by the NMR method of Example 3. First, the assay conditions were checked using the known amdS amidases from E. nidulans and its homologue from A. niger (Seq ID NO: 11).

TABLE 6
Conversion percentages of amide substrates
after 4 days of incubation.

| Transformant | Acrylamide | acetamide | Propionamide |
|---|---|---|---|
| Iso-508 | 0.3% | 1.5% | 1.8% |
| E. nidulans amdS | 19.7% | 100.0% | 100.0% |
| A. niger amd S | 0.3% | 11% | 7.5% |

It is clear that the empty host strain showed very low background activities on all the substrates. It is also clear that acrylamide is a much poorer substrate than the other two amides for these enzymes, and that the transformant expressing the A. niger amdS had much lower activities than the transformant expressing the E. nidulans enzyme.

TABLE 7
Conversion percentages of amide substrates
after 4 days of incubation.

| | acrylamide | Acetamide | propionamide |
|---|---|---|---|
| AAA | 0.1% | <0.5% | <0.5% |
| AAC | 0.6% | 0.7% | <0.5% |
| AAE | 0.9% | 1.5% | 2.2% |
| AAG | 0.2% | <0.5% | <0.5% |

It is clear that the absolute activities of these transformants are much lower than the ones presented in Table 6. However, this may be due to the non-optimised genetic constructs used for producing the experimental enzymes. But it is also clear that the relative activity of these enzymes for acrylamide compared to acetamide and propionamide is much higher than for the known amdS enzymes.

### EXAMPLE 8

### Measurement of the Aspergillus niger Secreted Amidases in Culture Supernatant

The activities of the preparations of the secreted amidases, that were also used for the SDS-PAGE analysis of Example 6, were determined with the colorimetric method.

TABLE 8
NH3 release by secreted amidases from amide substrates at pH 7.5

| | | propionamide | acetamide | acrylamide |
|---|---|---|---|---|
| amidase | time | NH3 (mg/l) | NH3 (mg/l) | NH3 (mg/l) |
| ZDO | 2 h | 0 | 0 | 0 |
| | 24 h | 104 | 29 | 5 |
| ZDK | 2 h | 0 | 0 | 0 |
| | 24 h | 3 | 0 | 0 |

It can be seen that the amidase ZDO has a preference for propionamide as a substrate. The relative activity towards acrylamide is comparable to the amdS amidases.

The apparent absence of activity for the ZDK enzyme prompted us to check the optimal pH for these enzymes with propionamide as substrate, using the following buffer systems (100 mM strength): Na-citrate for pH 3.0-5.5; Na-phosphate for pH 6.0-7.0; TRIS-HCl for pH 7.5-8.8. The results are presented in the Figures N and N.

It is clear that the failure to detect activity of ZDK at pH=7.5 is due to the sharp pH optimum of this enzyme in the acid region. In contrast, ZDO showed a broad, and bi-polar pH optimum. This may be related to the presence of two different proteins in the ZDO preparation.

The activity of the enzymes towards the various substrates was re-checked at the optimum pH value (determined with propionamide as a substrate). The results are shown in Table 9.

TABLE 9
Optical density values in NH3 analysis at optimal pH.

| | | | | | Urea |
|---|---|---|---|---|---|
| | | Propionamide | acetamide | acrylamide | OD(625 |
| amidase | time | OD(625 nm) | OD(625 nm) | OD(625 nm) | nm) |
| ZDO | 2 h | 0 | 0 | 0 | 0 |
| (pH 7.4) | 24 h | 0.230 | 0.140 | 0.023 | 0 |
| ZDK | 2 h | 0 | 0 | 0 | 0 |
| (pH 6.0) | 24 h | 0.600 | 0.026 | 0.034 | 0 |

Both enzymes have a preference for propionamide among the substrates tested. However, in the case of ZDO it must be borne in mind that this preference was determined at only one of the two pH-optima. If the bi-polar pH-activity relationship is indeed due to the presence of two different enzymes, or two different forms of the same enzyme, the substrate preference at the other optimum could be different.

From the OD values, the specific activity can be estimated, using an NH3calibration curve, and the estimated protein content. Specific activities of 0.7 and 0.2 mmol.min-1.mg-1 were calculated for ZDK and ZDO, respectively.

### EXAMPLE 9

### Amidases in Aspergillus niger and Other Micro-Organisms

The known sequence of these new amidases were used as a probe to find additional amidases in the genomes of other micro-organisms. A number of additional homologous enzymes were identified in fungi and bacteria.

### EXAMPLE 10

### Acrylamide Measurement in Food Samples

### Sample Pretreatment

600 mg dried and homogenized sample was extracted using 5 ml of milliQ water. 1 μg of internal standard 13C3 acrylamide in solution (CIL) was added to the extract. After 10 minutes of centrifugation (6000 rpm), 3 ml of the upper layer was brought on an Extreluut-3BT column (Merck). Using 15 ml of ethylacetate, acrylamide was eluted from the column. Ethylacetate was evaporated under a gentle stream of nitrogen, to bring the volume down to approximately 0.5 ml.

### Chromatographic Conditions

The ethylacetate solution was analysed using gas chromatography. Separation was obtained using a CP-Wax 57 (Varian) column (length 25 m, internal diameter 0.32 mm, film 1.2 μm) and helium as the carrier gas with a constant flow of 5.4 ml/min. Split-less injection of 3 μl was performed. Oven temperature was kept at 50° C. for 1 minute, after which the temperature was increased with 30° C./min to 220° C. After 12 minutes of constant temperature (220° C.), the oven was cooled down and stabilized before the next injection.

Detection was performed using on-line chemical ionisation mass spectrometry in positive ion mode, with methane as ionisation gas. The characteristic ions m/z 72 (acrylamide) and m/z 75 (13C3 acrylamide) were monitored for quantification.

Used Equipment

| | |
|---|---|
| GC: | HP6890 (Hewlet Packard) |
| MSD (mass selective detector): | HP5973 (Hewlet Packard) |

### Coffee Preparation

Concentrated enzyme solutions of ZDK and ZDO were prepared by ultrafiltration, and subsequently stabilized by addition of 50% w/v (final volume) glycerol, 0.02% (w/v) CaCl₂, 0.1% (w/v) methionine, and 0.1% (w/v) sodium benzoate. These concentrated stabilized solutions were shown to have amidase activities of 0.887 U/ml for ZDK, and 18.5 U/ml for ZDO, measured as μmoles of ammonia released per minute from 100 mM propionamide.

Freshly brewed coffee was divided into 6 ml portions, and incubated at 30° C. Subsequently, 0.3 ml amidase solution was added, and the incubation was continued at 30° C. An incubation in which 0.3 ml water was added instead of the enzyme solution was used as a control.

The samples were freeze-dried and analyzed for acrylamide according to the method described above.

| | acrylamide | percentage | percentage reduction |
|---|---|---|---|
| sample | (ppb) | reduction | per U enzyme |
| blank | 18.8 | 0 | |
| AmdS | 16.4 | 12.6 | |
| ZDK | 16.3 | 12.9 | 48.5 |
| ZDO | 14.4 | 23.3 | 4.2 |

1. A process for producing food comprising:
heating a food product to a temperature at which acrylamide is formed and
followed by adding an enzyme,
said enzyme being capable of modifying acrylamide.

2. The process according to claim 1, whereby the enzyme is added in an amount sufficient to lower in the food product the acrylamide by 50%, preferably by 70%, more preferably by 80% and most preferably by 90%, compared with food where no such enzyme has been added.

3. The process according to claim 1, wherein the food comprises roasted food products, preferably roasted coffee beans or parts or extracts of roasted coffee beans.

4. The process according to claim 1, wherein the food is a coffee product, preferably coffee beans, ground coffee, instant coffee, liquid coffee drinks, coffee extracts and the decaf version of coffee products.

5. The process according to claim 1 wherein the enzyme is an amidase.

6. The process according to claim 1 wherein the enzyme is capable of hydrolyzing short-chain non-cyclic amides.

7. An isolated polynucleotide hybridisable to a polynucleotide chosen from the group consisting of SEQ ID NO: 1 up to and including 11 or chosen from the group consisting of SEQ ID NO: 12 up to and including 22.

8. The polynucleotide according to claim 7 obtainable from a filamentous fungus.

9. (canceled)

10. An isolated polynucleotide encoding at least one functional domain of an amidase comprising an amino acid sequence chosen from the group consisting of SEQ ID NO: 23 up to and including 33 or functional equivalents of any of them.

11. (canceled)

12. A vector comprising a polynucleotide sequence according to claim 7.

13. A method for manufacturing a polynucleotide according to claim 7 or a vector comprising said polynucleotide sequence comprising culturing a host cell transformed with said polynucleotide or said vector and isolating said polynucleotide or said vector from said host cell.

14. An isolated amidase with an amino acid sequence defined in claim 10.

15. An isolated amidase according to claim 14 obtainable from Aspergillus niger.

16. An isolated amidase obtainable by expressing a polynucleotide according to claim 7 or a vector comprising said polynucleotide sequence in an appropriate host cell, e.g. Aspergillus niger.

17. A recombinant amidase comprising a functional domain of an amidase according to claim 14.

18. A method for manufacturing an amidase according to claim 14 comprising the steps of transforming a suitable host cell with an isolated polynucleotide hybridisable to a polynucleotide chosen from the group consisting of SEQ ID NO: 1 up to and including 11 or chosen from the group consisting of SEQ ID NO: 12 up to and including 22 or a vector comprising said polynucleotide sequence claim 12, culturing said cell under conditions allowing expression of said polynucleotide and optionally purifying the encoded polypeptide from said cell or culture medium.

19. A recombinant host cell comprising a polynucleotide according to claim 7 or a vector comprising said polynucleotide sequence according to.

20. A recombinant host cell expressing a polypeptide according to claim 14.

21. (canceled)

22. A food product obtainable by the process according to claim 1.

23. The polynucleotide according to claim 10 encoding an amidase comprising an amino acid sequence chosen from the group consisting of SEQ ID NO: 23 up to and including 33 or functional equivalents of any of them

24. The polynucleotide according to claim 7 comprising a nucleotide sequence chosen from the group consisting of SEQ ID NO: 1 up to and including 11 or chosen from the group consisting of SEQ ID NO: 12 up to and including 22 or functional equivalents of any of them.
